(19) United States
(12) Patent Application Publication
(10) Pub. No.: US 2026/0337978 A1
(43) Pub. Date: Oct. 29, 2026

(54) METHOD FOR APPLYING A PRESSED BEVEL TO A DECORATIVE PANEL, A DECORATIVE PANEL, AND A DEVICE FOR PRODUCING AT LEAST PART OF A DECORATIVE PANEL

(71) Applicant: CFL Holding Limited, Hong Kong (HK)

(72) Inventors: Thomas Luc Martine BAERT, Sint-Martens-Latem (BE); Tom VAN POYER, Jiaxing (CN); Sven BOON, Jiaxing (CN)

(73) Assignee: CFL Holding Limited, Hong Kong (HK)

(21) Appl. No.: 19/556,395

(22) Filed: Mar. 4, 2026

(30) Foreign Application Priority Data
Apr. 28, 2025 (NL) 2040261

(51) Int. Cl. E04F 15/02; B23C 3/12

(52) U.S. Cl. CPC E04F 15/02033; B23C 3/12; E04F 15/02038; E04F 2201/023

(57) ABSTRACT

Method for applying a pressed bevel to a decorative panel. The method comprises (a) providing a decorative panel comprising a core layer and a decorative top layer, and an upper surface and a pair of opposing side edges, wherein the core layer comprises a thermoplastic composite material; (b) precutting at least part of the side edge of the panel and core layer; (c) locally heating a predetermined region of the upper surface of the panel along an outer edge with a laser; (d) deforming at least part of the heated upper surface of the panel such that a pressed bevel is formed at the side edge of the panel; and (e) subjecting the at least one side edge of the core layer to a milling process wherein at least one coupling structure is formed. The method is performed at a production speed of at least 30 meters per minute.

### CROSS REFERENCE TO RELATED APPLICATIONS

This application claims priority under 35 U.S.C. § 119 to Dutch Patent Application NL 2040261, filed on Apr. 28, 2025. The entire contents of each of this prior application is hereby incorporated herein by reference.

### FIELD OF THE INVENTION

The present invention relates to a method for applying a pressed bevel to a decorative panel, a decorative panel, and a device for producing at least part of a decorative panel.

### BACKGROUND

Using decorative panels on walls, floors, or ceilings is widely known. One of the purposes of a panel is to provide a realistic, pleasing decorative aesthetic in a living or working space. To achieve greater realism, a high-resolution print, a synchronized texture, or a high-or low-gloss surface may be provided. One particular method to provide realism to a panel involves applying a distinct, tactile beveled edge, such as a pressed bevel, to at least one side edge of the panel. Such a pressed bevel entails mechanically displacing material from at least one upper-facing decorative layer on at least one side edge of a panel to provide a visual depth effect between adjacent panels. Such a pressed bevel may be applied during a pressing step or an extrusion-lamination-embossing process of the panel. Producing a panel having a pressed bevel according to such a known method has multiple drawbacks. First, during the panel's extrusion-lamination-embossing process, it may be prone to stretching. Since the panel is during said process in a malleable thermoplastic state, it may be stretched up to 2 to 5%. This is due to flow fluctuations in the extruded melt exiting the die and stresses exerted on the panel during the lamination process. This then causes issues with length alignment of at least 1% when panels provided with such a pressed bevel are cut and milled to a standard specification, resulting in a misaligned position of the pressed bevel on the panel edge, specifically the edges perpendicular to the extrusion direction, and unsightly height differences outside of acceptable standards. In order to create a consistent and high-quality decorative covering comprising multiple panels comprising a pressed bevel, the presence of such height differences between two opposing pressed bevels is highly undesired. To address the aforementioned downside, the prior art proposed using stretching markers and adjusting the rotational speed of the embossing roller. This use of stretching markers can contribute to minimizing dimensional differences, in particular uneven stretching of the malleable panel. The solution, however, merely compensates for the stretching of the malleable panel and does not overcome the occurrence of the stretching. Another drawback of the use of stretching markers is the increasing complexity of the production process, for example due to the need of sensors, control units, and height adjustment mechanisms. A further downside of the use of stretching markers is the significant reduction of rotational speed of the embossing roller. Even though this reduction allows to reduce the stretching, the production output significantly decreases leading to a more costly manufacturing process of a panel, in particular in high-volume manufacturing environment, and requires continuous monitoring of the deformation of the thermoplastic materials and the stretching panel during its production. Moreover, the way of forming bevels according to the current solutions may cause, by virtue of material displacement, internal stresses in the resulting panels. These stresses are not beneficial as they may e.g., result in (slight) deformation of the bevel or panel as a whole. The stretching of a panel by conventional means prevents the formation of a deep pressed bevel, particularly on the short sides of a panel (opposing edges in a machine direction), as misalignment in further processing would lead to unsightly height differences.

Applying a pressed bevel using a roller or traveling press during the extrusion-lamination process may introduce additional stress to the panel while it is still in a heated and malleable state, particularly when heated embossing tools are used. This mechanical stress, combined with the directional stretching and anisotropic properties of the extruded polymer core, may lead to internal stress buildup within the panel. As a result, when subjected to dimensional stability tests (e.g., ISO 23999) or exposed to thermal cycling, the panel may exhibit undesirable effects such as warping, shrinkage, or surface texture/bevel rebound. Introducing an annealing step to relieve these stresses is not a viable solution, as it would cause unwanted dimensional changes to the provided texture, thereby worsening issues like misalignment and height variation.

Additionally, using a single embossing roller to apply both the Embossed-In-Register (EIR) texture and the bevel creates design limitations, as each application of embossing and/or pressed bevel requires distinct rollers for distinct sizes, whereas a regular embossing or texture may be used to produce multiple sizes of the product. To overcome this, a multi-step process may be implemented, where the EIR texture is applied first with an embossing roller, and a bevel is formed in a subsequent step using a press plate or a roller. However, this adds complexity and cost to the production line.

Another challenge is the material rebound seen in thermoplastic materials. These materials can exhibit elastic recovery, causing the bevel to partially revert to its original shape over time, especially if the panel is still warm from extrusion or the bevelling occurs at high temperatures. This can result in inconsistent bevel depth or shape across different sections of the panel. Although cooled rollers may help reduce this effect, they may not be sufficient to eliminate it entirely when the panel core remains warm and malleable, i.e., remains above its glass transition and/or Vicat softening temperature.

Prior art systems that apply a bevel to a large, continuously extruded panel using compression—either via roller or press—face limitations related to material displacement. When a solid thermoplastic mass is compressed without a designated space for displaced material, it can lead to unintended deformation on both the top and bottom surfaces of the panel. This deformation negatively impacts the panel's thickness uniformity and the consistency of surface textures, ultimately affecting the overall aesthetic and dimensional quality of the finished product.

Said conventional methods are also hindered by slow production speeds.

Because the bevelling process requires careful control of panel stretching and material deformation, the overall line speed is typically restricted to around 2 to 3 meters per minute. This slow rate poses a major limitation for high-throughput manufacturing, making the process less efficient and more costly in large-scale operations.

It is therefore a goal of the invention to provide a method for producing a panel, or a panel having a pressed bevel, while addressing at least some shortcomings of the prior art, and enhancing the production output during the production process of the panel.

Another goal of the invention is to provide a method for producing a panel, or a panel, having a pressed bevel wherein the presence of height difference of the pressed bevel between panels is minimized.

### BRIEF DESCRIPTION OF THE DRAWINGS

The invention will be further elucidated by means of non-limiting exemplary embodiments illustrated in the following figures, in which:

FIG. 1A shows a cross-sectional side view of a long side of an embodiment of a panel according to the present invention, wherein a slit or seam is provided;

FIG. 1B shows a perspective side view of an embodiment of a panel according to the present invention comprising a pressed bevel;

FIG. 2 shows a schematic representation of the method according to the present invention;

FIG. 3 illustrates an embodiment of the method;

FIG. 4 illustrates a cross-sectional view of two adjacent pressed bevels; and

FIG. 5A-5F illustrate different schematic examples of an aspect of the invention; and

FIG. 6A-6E illustrate cross-sectional views of decorative panels according to the present invention.

### DETAILED DESCRIPTION

A method for applying a pressed bevel to a decorative panel, comprising the steps of:
a) providing at least one decorative panel, said panel comprising at least one core layer and at least one decorative top layer, and an upper surface and at least one pair of opposing side edges;
wherein the at least one core layer comprises at least one thermoplastic composite material;
b) precutting at least part of at least one side edge of the panel and in particular of the at least one core layer;
c) locally heating a predetermined region of the upper surface of the panel along an outer edge with at least one laser;
d) deforming at least part of the heated upper surface of the panel, in particular the predetermined region, such that at least one pressed bevel is formed at the at least one side edge of the panel, in particular formed along a side edge, preferably on at least one short side edge and/or at least one long side edge of the panel;
e) subjecting the at least one side edge of the core layer to a milling process wherein at least one coupling structure is formed, said coupling structure comprising at least one tongue and/or at least one groove;
wherein steps c) and d) are performed substantially simultaneously such that it allows to perform the method at a production speed of at least 30 meters per minute.

The step b) precutting is optional and may comprise and/or is performed by milling, cutting, removing. Preferably, during step b) at least one slit is provided into at least part of at least one side edge of the panel and in particular of the at least one core layer, optionally wherein the at least one slit is formed at an angle of at least 1 degree, preferably at least 5 degrees, preferably at least 10 degrees, more preferably 30 degrees, even more preferably at most 30 degrees, and at most 40 degrees with respect to an upper surface of the panel, even more preferably at most 60 degrees with respect to an upper surface of the panel. Preferably, during step c) at least part of the predetermined region overlaps with at least part of the at least one slit. Preferably, during step d) at least part of the predetermined region overlaps with at least part of the at least one slit.

The method is preferably performed after the extrusion-lamination or the extrusion-lamination-embossing process of a sheet. After the extrusion-lamination process, the sheet can be cut optionally into individual panels on which a bevel can be applied. Preferably, the method is performed after coating, conditioning, annealing and/or cutting of the sheet into panels. Applying at least one pressed bevel after the extrusion-lamination, extrusion-lamination-embossing and/or annealing process may eliminate stretching of a panel which occurs in the situation wherein the pressed bevel is applied during the extrusion-lamination process. The steps of the method according to the invention allow to run at an increased production speed, for example a production speed of at least 20 meters per minute, and even 30 meters per minute. The production method allows to manufacture at a speed of at least 30 meters per minute, preferably at least 60 meters per minute, and most preferably at least 90 meters per minute. These relatively high production speeds offer a significant advantage, in particular in high-volume manufacturing environments, as it makes the production process cost-efficient, in particular compared to methods provided in the prior art wherein production speeds are generally limited by 2 to 3 meters per minute. The increased production speed can in particular be achieved by applying the pressed bevel after the extrusion-lamination process, preferably before or during the profiling or milling step. This allows the step of locally heating and/or the step of locally deforming to be performed more rapidly and efficiently without the need for an additional production step.

It is conceivable that the method of producing the panel combines the conventional method of applying at least one pressed bevel during extrusion-lamination-embossing step on at least one edge of the panel, preferably on at least one long side edge of the panel and consecutively applying at least one pressed bevel according to the present invention on at least one other edge of the panel, preferably on at least one short side edge, preferably after extrusion-lamination process, preferably before or during the profiling or milling step.

The precutting step and/or the step of providing a slit, while optional, may be an important contribution to key advantages, contributing to dimensional and positional consistency along the side edge of the panel, in particular before local heating and/or pressing. By establishing a consistently defined edge profile, for example through milling, cutting, and/or material removal, said precutting step or slit provision step enables precise targeting of the region to be heated and/or deformed. Without this step, variations in panel size or edge geometry could result in inconsistent heating and pressing, potentially affecting the depth, position, or quality of the applied bevel or surface structure. The edge resulting from the precutting step or slit provision step contributes to improved and repeatable alignment and engagement with downstream processing tools, such as embossing rollers or press plates. This consistency is difficult to achieve with untreated or irregular edges (e.g., raw rib-sawed edges), which may introduce surface inconsistencies and alignment challenges. Further, the step of providing at least one slit is an optional step or alternative step that may be selectively applied to enhance deformability, reduce internal stress, or allow for more defined bevel features.

In other embodiments, step b) may be omitted under specific heating configurations. It has been found that by utilizing at least one laser heating and/or infrared laser heating step over an extended heating distance along the production axis of the device according to the invention, the predetermined region of the panel can be softened sufficiently to allow for deformation of a solid or foamed core without the need for prior material removal and/or the application of stress-relief slits. The laser heating and/or infrared laser heating is preferably applied over a continuous laser heating length of at least 150 mm, more preferably at least 200 mm, and most preferably at least 250 mm. In certain configurations, the laser heating length or distance may extend up to 350 mm, more preferably up to 400 mm, most preferably up to 450 mm. This extended laser heating length ensures that even at industrial production speeds of at least 30 meters/minute, more preferably at least 60 meters/minute, the thermal energy has sufficient dwell time to penetrate the upper portion of the panel to the required depth.

Said laser heating at this configuration allows to heat up said edge region to a temperature of at least 80 C, more preferably at least 90 C, most preferably at least 100 C and at most 170 C, more preferably at most 160 C, most preferably at most 150 C at a surface of the heated region. In a particularly advantageous embodiment, said laser heating heats up said edge region to 110-140 C before deformation. This specific configuration surprisingly overcomes the material rebound and internal stress issues typically associated with deforming untreated, solid thermoplastic masses and allows to omit the precutting step prior to heating and deforming of the at least one panel edge. The extended laser heating length allows for a gradual yet intense thermal exposure through continuously or uninterruptedly provided heating that renders the decorative top layer and/or core material sufficiently malleable for the pressing step to displace the material internally and/or into the structure of the core.

While the precutting step (Step b) may be omitted prior to the laser heating and/or edge deformation step, the invention also contemplates a particular embodiment where a milling or cutting step may be employed after the laser heating and/or edge pressing steps, but prior to the final edge tenoning, milling or profiling process (Step e). This sequence allows the tenoning tools to work on a full-material edge, with any subsequent edge refinement occurring just before the formation of the tongue and groove coupling structures.

By applying a pressed bevel, compressive forces are subjected to at least a part of a side edge of the panel. A slit provided into at least part of the side edge of the panel advantageously allows to accommodate displaced or compressed material. This allows the material of the panel to deform more readily, thereby reducing the risk of cracking while requiring less force and/or heat. The presence of the slit can further prevent unwanted deformation of the top and bottom surfaces of the panel and in particular prevent the occurrence of rebound of the material of the panel and may contribute to reducing the residual stresses in the resulting product. The slit is preferably arranged in the core layer thereby allowing the decorative top layer to be left uninterrupted, which contributes to an—for a user—appealing visual effect. Moreover, the presence of the slit enables to eliminate the step of stretching the panel in order to apply a pressed bevel. The disadvantages occurring due to stretching can therefore be prevented. Further, the step of providing a slit allows to accurately remove a part of the side edge of the panel, which contributes to a consistent and high quality (floor) covering comprising multiple panels, which is substantially free of height differences of two opposing pressed bevels. Said accurate removal of part of the side edge may also contribute to the predictability of the deformation of at least part of the side edge of the panel, thereby ensuring that the pressed bevel is substantially consistent and substantially without unwanted surface irregularities, cracking and/or deformation of the bottom surface of the panel.

The step of llocally heating may increase the malleability of a part of the panel, in particular the predetermined region, such that said part becomes more receptive to deformation. Also, llocally heating can prevent deformation of the whole panel, in particular compared to completely heating of the panel which will cause said deformation of the whole panel. Furthermore, locally heating can significantly save energy compared to heating the entire upper surface of the panel. The heating step is performed by preferably continuously or uninterruptedly contact heating and/or focused heating of the predetermined region of the upper surface of the panel along the side edge. The predetermined region can be understood as the part of the upper surface that is (locally) heated. The size of the region (the part of the upper surface that has to be heated) is determined before heating of the panel, such that in particular only the upper surface of the panel where the bevel is pressed will be heated.

The heating of the predetermined region can take place before and/or during the deformation of at least part of the heated upper surface of the panel. By heating a panel, a rebound in the material can occur, in particular if the panel comprises thermoplastic material, due to elastic behavior of material, in particular thermoplastic material, in the panel. Said behavior can cause the pressed bevel to relax or return to its original shape over time. This may lead to (slight) variations in the shape of pressed bevels and the height of the pressed bevels between adjacent panels, when in a coupled state. This may contravene a consistent result along the side edge of the panel. By locally heating, the potential for rebound in the material can be mitigated as much as possible, in particular when prior to the step of locally heating the optional step of precutting, such as in providing a slit, is performed. Moreover, locally heating aids in preventing stretching of the panel during the application of a pressed bevel as the panel is only preheated topically. The disadvantages occurring due to stretching can therefore be prevented. Furthermore, by locally heating the production process can be simplified, in particular there is no need for sensors, control units, and height adjustment mechanisms required. Additionally, contrary to the prior art, limitations in production output due to a decreased rotation speed of the embossing roller in order to stretch the panel are no longer present. Consequently, the production output can significantly increase leading to a cost-efficient manufacturing process of a panel, in particular in a high-volume manufacturing environment.

The deforming step allows to achieve a rounded profile, such that the presence of sharp edges can be prevented, and a continuous, aesthetically pleasing appearance can be obtained. Alternatively or additionally, a random and/or complex profile may be provided, such as a multi-step impressed bevel, an arc bevel, a u-shaped bevel, a chiselled edge, and/or a pressed angular bevel.

The step of subjecting the at least one side edge of the core layer to a milling process allows to remove material from the at least one side edge of the core layer in order to form a coupling structure, such as a male and female receiving parts, in particular at least one tongue and at least one groove. It is conceivable that the milling step e) is applied before or after step d) of deforming at least part of the heated upper surface of the panel such that at least one pressed bevel is formed at the at least one side edge of the panel. A height of a side of a downward tongue facing away from a downward groove can be determined by the pressed bevel, in particular the lowest point of the pressed bevel. A height of a side of the panel facing towards at least one upward groove can be determined by the pressed bevel, in particular the lowest point of the pressed bevel.

The method can be suitable to be at least partially integrated into extrusion-lamination process, which is advantageous in terms of process integration. This is beneficial over applying a separate coating method.

It is conceivable that the pressed bevel is applied on at least one short side and/or at least one long side of the panel. During the step of deforming, the slit can at least partially be sealed, thereby forming a seam. Alternatively or additionally, it is also conceivable that the seam can be formed during a sealing step.

Preferably, the steps are subsequent steps. The pressed bevel is preferably applied before forming the coupling structure. This sequence of method steps allows to more accurately position the coupling structure. Furthermore, it is preferred to apply a slit before locally heating and/or locally deforming of at least part of an upper surface of the panel. This slit encompasses a space into which the deformed material of the panel can be displaced. This can effectively prevent unwanted deformation of the top and bottom surfaces of the panel. The slit can then contribute to optimally arrange the pressed bevel.

Typically, steps c) and d) are performed substantially simultaneously. This may enhance the production speed, in particular to achieve a production speed of at least 30 meters per minute, preferably at least 60 meters per minute, and most preferably at least 90 meters per minute. In the context of the application, for steps c) and d) to be performed simultaneously, or substantially simultaneously, may be understood as these steps to be performed one after the other within such a short time span that the heated predetermined region, ideally, does not cool at all or, at least, not cool by any significant or even observable amount. In a preferred embodiment, steps c) and d) may be considered substantially simultaneously or simultaneously if the heated predetermined area cools, between finishing step c) and starting step d), less than 10 C, preferably less than 5 C, more preferably less than 1 C.

Preferably, the method further comprises a step of sealing at least part of at least one slit in particular prior to at least one coupling structure is formed, wherein preferably a seam is formed. Optionally, said step is performed prior to step f). Preferably, at least part of at least one slit is sealed during the formation of at least one pressed bevel. The sealing step can be partially performed during step d) of deforming. It is also conceivable that the sealing step is at least partially performed after performing step d) of deforming. After forming of the pressed bevel, the slit can at least partially, or optionally locally, be sealed, or welded such that the slit can at least partially be closed. The sealing step can optionally be performed by heating at least part of the slit. It is conceivable that at least part of the sealing step is performed by using at least one laser, heated roller, or focused infrared heating and/or by applying a solvent and/or an adhesive to at least a part of an inner side of the slit. This step can serve to further stabilize the part of the panel where the slit is provided, and can provide an improved surface finish to the bevel, also providing additional protection against moisture ingress and delamination. As an alternative or additional step, an adhesive or solvent may be applied to at least part of the inside walls of said groove prior to the application of pressure to form said at least one pressed bevel.

Optionally, the location of at least part of the locally heated region overlaps with at least part of the position of the at least one slit. Preferably, at least part of the heated upper surface of the panel is deformed such that a pressed bevel is formed. Said part of the heated upper surface can accommodate the deformed material of the panel. Said at least partial overlap of at least part of the locally heat region and at least part of the position of the slit allows to optimally accommodate the deformed material.

At least one slit may be an uninterrupted slit. This contributes to the predictability of the behaviour of the material of the panel that will be pressed. The deformation of the material due to locally heating can therefore better be predicted. This allows to enhance the reliability of the position of the pressed bevel. Further said slit can prevent or mitigate unwanted deformation. It is also conceivable that the slit is an interrupted slit. Preferably, the slit protrudes or recedes or extends inwardly, preferably in a substantially horizontal plane, relative from a side edge towards a central region of the panel, wherein a thickness of the slit is typically constant or has a uniform thickness along a width and/or length of the slit. In this respect, thickness can also be understood as height. Optionally, the slit has a width situated in range of 0.5-6 mm, preferably 0.75 to 4 mm inwardly extending or protruding from a side edge of the panel.

It is thinkable that the slit of step b) has a rectangular, a square, a triangular, or a trapezoid shape. In a preferred embodiment, the slit has a triangular shape, which shape can optimally arrange the curve of the pressed bevel, in particular when the slit has an angle a of preferably at least 5 degrees relative to the upper surface of the panel. It is also conceivable to apply different shapes of the slits, depending for example on the type of material of the panel.

In an advantageous embodiment at least one slit extends at least 0.2 mm into the core layer, in particular at least 0.4 mm, more in particular at least 0.6 mm. In a preferred embodiment, the slit has a depth within a range of 0.1 to 2 mm, preferably between 0.5 to 1 mm. A thickness of a panel is preferably between 1-18 mm, preferably 2-15mm, most preferably 3-12mm.

It is conceivable that in an the core layer may have a thickness of at most 8 mm, more preferably at most 6 mm, and most preferably at most 4 mm, in particular wherein the core layer is a single core layer. Alternatively the panel comprises two core layers, it is conceivable that the thickness of each individual core layer has a thickness within a range of 1 mm to 4 mm, such that the cumulative thickness of the core layers contributes to a total panel thickness preferably at most 6 mm or at most 5 mm. However, it is possible for the core layer to have a thickness of up to 18 mm, preferably up to 15 mm, most preferably up to 12 mm thickness. Further, the panel according to the invention may comprise at least three core layers. In said embodiment, said at least one core layer comprises at least one partially foamed core layer. It is plausible that said foamed core layer may have a thickness ranging from 1 mm to 5 mm, potentially situated between two solid core layers each having a thickness of 0.5 mm to 2 mm, with the total thickness of the core layers preferably remaining at most 8 mm, more preferably at most 6 mm, or most preferably at most 4 mm. It is conceivable that at least one foamed layer functions at least partially as a compressible material to allow compression of the at least one pressed bevel, especially without the need for providing an additional slit. Said foamed layer advantageously allows to accommodate displaced or compressed material during bevel formation, possibly reducing or eliminating the necessity for a separate slit. It is conceivable that the total thickness of the at least one core layer amounts to at most 18 mm, more preferably at most 15 mm, and most preferably at most 12 mm, or ranges between 3 mm to 8 mm thickness. It is further contemplated that the specific thickness of each core layer in multi-layered arrangements may be determined in relation to the overall desired panel thickness and the functional requirements of the decorative panel.

In a preferred embodiment at least one heating step is performed with a focused laser. In a preferred embodiment, said focused laser is a focused infrared laser, most preferably a lineally focused laser, a line laser and/or a laser line generator. Preferably, during the heating step, the heating is continuously or uninterruptedly provided on the panel, in particular on a predetermined region. After applying the pressed bevel, it is conceivable that the previously provided or milled slit may be at least partially or locally welded by a heating step. This step can serve to further stabilize the part of the panel where the slit is provided, and can provide an improved surface finish to the bevel, also providing additional protection against moisture ingress and delamination.

Typically, deforming at least part of the heated upper surface is done by at least one bevelling section, comprising at least one surface pressing structure, preferably a roller, and at least one back support structure. The co-action between the surface pressing structure and the back support structures contributes to optimally arranging the pressed bevel. Further, such a surface pressing structure, in particular a roller, or back support structure, allows a uniform distribution of force and prevents unwanted deformation of the at least one panel and/or core layer beneath the plane of the bottom surface of the panel.

It is contemplated that locally heating may also be applied to at least one predetermined region of the panel in such a way that primarily the upper portion of the panel and/or the core layer is affected (heated). Preferably, the central or more inward region of the upper surface remains largely unaffected (unheated) by the applied heat.

Possibly, locally heating of at least one predetermined region is performed such that at least a central region of the upper surface of the panel is substantially unaffected by the heating step, in particular wherein, preferably only, an upper portion of the panel is heated, in particular a thickness (otherwise referred to as depth) situated in range of 0.4-4 mm, preferably at least 0.5 mm, more preferably at least 0.6 mm, even more preferably up to 4 mm, even more preferably up to 3 mm, even more preferably up to 2 mm, most preferably in range of 0.6-1.3 mm extending from an upper surface of the panel towards a bottom surface of the panel. Said slit may extend through at least part of at least one decorative top layer, at least one wear layer, at least one coating layer, at least one reinforcing layer, and/or at least one core layer. The heated zone preferably spans a width of approximately 0.5 to 6 mm, more preferably 0.75 to 4 mm, measured from the outer edge of the panel. The local heating preferably affects a region extending at least 0.40 mm from the upper surface of the panel, more preferably at least 0.50 mm, and most preferably at least 0.60 mm. Conversely, the maximum depth affected by the heating is preferably no more than 4 mm, more preferably 3 mm, and most preferably 2 mm. In a particularly preferred embodiment, the heating affects a depth in the range of 0.6 mm to 1.3 mm. Said depth may comprise (in particular extend through) at least partially at least one decorative top layer, at least one wear layer, at least one coating layer, at least one reinforcing layer, and/or at least one core layer.

It is conceivable that the method further comprising at least one cooling step after step d). Preferably, the material of the panel is capable of maintaining its structural integrity after the step of deforming, wherein the rebound of the material of the panel needs to be minimized. By performing a cooling step, the material of the panel can be set into its new shape. The cooling step can be at least partially integrated with or at least partially performed during the step of deforming. The back support structure, such as a roller, can ensure uniform distribution of force. Optionally, the cooling step can be performed after the sealing step, in particular after the step of providing a slit.

In another possible embodiment, the at least one panel has a total thickness t, and comprises at least one slit, said slit comprising at least one of, preferably two of the following features: a lower landing, an upper landing, and/or an interior wall. The lower landing may be situated at least partially parallel to the bottom surface of the panel, but in some cases, it may be oriented at an angle of at least 5 degrees relative to said bottom surface. Similarly, the upper landing may be situated at least partially parallel to the upper surface, or alternatively, it may also be oriented at an angle of at least 5 degrees with respect to said upper surface. Preferably, the lower landing and/or upper landing intersect with the distal edge of the panel at respective depths referred to as d(slit, lower) and d(slit, upper). The vertical distance from the upper surface of the panel down to d(slit, upper) is defined as the upper slit thickness. The inner wall of the slit forms the boundary between the upper and lower landings, and may have a curved, straight, or angled geometry. It is likewise conceivable that the slit only comprises an upper landing.

Optionally, the at least one slit may be formed at an angle with respect to the upper surface of the panel exceeding 40 degrees and extending up to, for instance, 70 degrees. Such a steeper angle may potentially facilitate a more pronounced material displacement during the deformation step, potentially leading to a more sharply defined pressed bevel with enhanced tactile distinctiveness. Conversely, the at least one slit may also be formed at a shallower angle of less than 5 degrees, approaching parallelism with the upper surface. This near-parallel configuration might allow for a subtler bevel formation for aesthetic variations or could influence the characteristics of any subsequently formed seam. Furthermore, it is conceivable that the at least one slit is formed at a predetermined angle with respect to the edge surface of the panel rather than the upper surface of the panel, for example, at an angle ranging from 0 degrees (parallel to the edge surface, effectively a notch) to 45 degrees inwardly. A slit oriented substantially parallel to the edge surface could promote a more direct accommodation of displaced material during pressing of the at least one bevel, potentially minimizing deformation on the upper and/or lower surfaces of the panel. An inclined slit relative to the edge surface might influence the undercut of the pressed bevel, potentially affecting the geometry and strength of any interlocking coupling structure subsequently formed.

The inner wall of at least one slit may, either directly or indirectly, connect the upper and/or lower landings, and is preferably the innermost, most proximal boundary of the slit. The horizontal distance between this inner wall and the distal edge of the panel is referred to as the slit width.

The local heating is preferably applied to a predetermined region that includes at least the distal edge of the upper lip or upper landing and/or the upper surface of the upper lip or upper landing, extending toward the proximal center region of the panel. More specifically, heating is applied to at least the region spanning from the distal edge to the slit width. The upper slit thickness may partially or fully include one or more of the following layers: the decorative top layer, the wear layer, any coating layers, reinforcing layers, and/or a portion of the core layer. The upper slit thickness preferably ranges from 0.5 mm to 3 mm, and more preferably from 0.7 mm to 2 mm. The slit width preferably ranges from 0.5 mm to 6 mm, and more preferably from 0.75 mm to 4 mm.

In another conceivable embodiment, the at least one bevel may extend deeper than the entire decorative top layer, while other bevels may be either shallower or also deeper. The pressed bevels are preferably designed to maintain uniform thickness and length, with an evenness tolerance of up to 0.1 mm.

It is imaginable that the at least one core layer comprises at least one thermoplastic composite material. Said core layer comprising the at least one thermoplastic composite material having a Vicat softening temperature of at least 60 degrees Celsius. Preferably, the at least one decorative top layer has a Vicat softening temperature of at most 70 degrees Celsius and/or wherein the Vicat softening temperature of the at least one decorative top layer is at least 10 degrees Celsius lower than the Vicat softening temperature of the at least one core layer. Said Vicat softening temperature allows to increase the malleability and deformation of the panel, in particular the core layer and/or decorative top layer, while also maintaining its structural integrity and aesthetic quality. The ability to control the Vicat softening temperature of the core layer and decorative top layer allows for precise and repeatable deformation. The step of locally heating and the step of locally deforming steps contribute to avoid unwanted stretching and misalignment of the pressed bevel, which can cause height differences on the side edges of the pressed bevels.

Typically, the step of locally heating, preferably of at least the decorative top layer and/or the core layer, is performed at a temperature at least 5 degrees Celsius, preferably at least 10 degrees Celsius, above a Vicat softening temperature of the core layer. The step of locally heating is preferably performed at a temperature of at least 65 degrees Celsius, preferably at least 70 degrees Celsius, more preferably at least 75 degrees Celsius, most preferably at least 80 degrees Celsius. Optionally, the step of locally heating of at least the decorative top layer is performed at a temperature within a range of 5 to 20 degrees Celsius, preferably in a range of 10 to 20 degrees Celsius, more preferably within a range of 15 to 20 degrees Celsius, even more preferably 20 degrees Celsius above a Vicat softening temperature of the core layer. Said temperature difference can allow the core layer material to controllably deform during the heating step, while any damage to the decorative top layer can be prevented. Preferably, the step of locally heating a predetermined region of the upper surface of the panel along an outer edge may contribute to soften the material of the panel such that it can deform, while melting, burning, and/or weakening of the panel, in particular the upper surface, can be prevented.

Optionally, the panel is locally heated to a temperature approximately 10 degrees Celsius above the Vicat softening point of the core layer, which typically has a Vicat point of at least 60 degrees Celsius. This implies a minimum heating temperature of 70 degrees Celsius, preferably 75 degrees Celsius, and most preferably 80 degrees Celsius or higher. Ideally, the decorative top layer is heated to a temperature at least 10 degrees Celsius above the core's Vicat point, allowing for controlled softening while preserving the integrity of the layered structure. It is conceivable however that the at least one core layer has a Vicat softening point of at least 40 degrees Celsius, such as in the case of at least partially foamed core layers. For instance, if the core has a Vicat softening point of 70 degrees Celsius, the decorative top layer would be heated to at least 80 degrees Celsius; if the Vicat point is 75 degrees Celsius, the heating temperature would be at least 85 degrees Celsius. The decorative top layer may be heated to a temperature at least 5 degrees Celsius, preferably 10 degrees Celsius, above the Vicat softening point of the core. Alternatively, heating may be based on the glass transition temperature (Tg) of the core, with the decorative top layer heated to a temperature at least 5 to 10 degrees Celsius, more preferably 10 to 15 degrees Celsius, and most preferably 15 to 20 degrees Celsius above Tg.

The method may further comprise a step of cooling, after locally heating the panel. By maintaining a low temperature—specifically, at least 20 degrees Celsius below the Vicat softening point of the decorative top layer and/or core layer—, in particular after subjecting the decorative top layer and/or core layer to the locally heating step may enable the thermoplastic material to cool below the glass transition temperature (Tg) of the respective layers. This temperature drop helps prevent rebound in the material. Rebounding is a phenomenon observed in long-chain polymers, where deformation introduces internal stresses within the composition. When exposed to elevated temperatures, these stresses may cause the material to relax or return toward its original shape, leading to loss of the applied surface texture or reduction in the depth and/or definition of the intended surface structure. By cooling the material below Tg, such rebound effects can be effectively minimized or avoided. This is also particularly advantageous when applying a relatively deep texture, such as larger than 0.10 mm, preferably larger than 0.15 mm, more preferably larger than 0.20 mm depth. This is also particularly advantageous when a texture is applied in an at least partially foamed core (or optionally at time of application of a texture, still undergoing foaming in at least part of the volume of the core), as it will solidify the polymeric melt to below its Tg and/or halt the foaming process, thereby creating a rigid support structure. This temperature difference allows the core material to deform in a controlled manner when heated while preventing any damage to the decorative top layer. Preferably, the localized heating along the panel's edge should soften the material enough to permit deformation, yet remain low enough to avoid melting, burning, or weakening the panel surface structure. Possibly, one heating step, which can be combined with any prior heating step performed at another region, may be performed at a sufficiently high temperature to allow for thermolamination of at least two slit walls present in the panel.

In a preferred embodiment, the method is performed at a production speed of at least 30 meters per minute, preferably at least 60 meters per minute, and most preferably at least 90 meters per minute.

Preferably, the method further comprises the step of aligning the at least one decorative panel prior to the at least one milling and/or heating step. It is thinkable that the step of aligning is at least partially performed before or during two or more of the method steps. Typically, the alignment of the decorative panel in step a) is performed using chains, bands, rules, and/or pressing rollers. Said alignment is beneficial to accurately position a panel with respect to a structure or section that performs a method step.

In an embodiment, the method comprising the steps of milling at least one first slit into at least part of at least one first side edge of the panel and in particular of the at least one core layer and least one second slit into at least part of at least one second side edge of the panel and in particular of the at least one core layer which opposes the first side edge, and locally heating at least two predetermined regions of the upper surface of the panel, wherein at least part of a first predetermined region overlaps with at least part of the at least one first slit and wherein at least part of a second predetermined region overlaps with at least part of the at least one second slit, and deforming at least part of the heated upper surface of the panel such that at least one first pressed bevel is formed at the at least one first side edge of the panel and at least one second pressed bevel is formed at the at least one second side edge of the panel. Typically, the method comprising the step of subjecting the at least two opposing side edge of the core layer to a milling process wherein complementary coupling structures are formed, wherein each coupling structure comprises at least one tongue and/or at least one groove. This can contribute to a realistic looking panel having a pressed bevel on at least two side edges, in particular two opposing side edges, of the panel.

In a preferred embodiment, the step e) of subjecting the at least one side edge of the core layer to a milling process wherein at least one coupling structure is formed, is performed after step d). It is also conceivable that step e) is performed prior to step d), preferably prior to step b).

The present invention moreover relates to a decorative panel produced by a method according to any the invention. With regards to the panel obtained or produced by the method according to the invention the same benefits as elucidated with respect to the method above apply mutatis mutandis to this panel as such.

The present invention further relates to a decorative panel, in particular a floor, wall or ceiling panel, comprising:
at least one core layer, preferably having an upper surface; and
at least decorative top layer, optionally directly or indirectly affixed to the upper surface,
wherein the panel comprises an upper surface and at least one pair of opposing side edges, wherein at least one side edge comprises at least one coupling structure, preferably wherein the at least two opposing side edges comprise complementary coupling structures each comprising at least one tongue and/or at least one groove;
wherein at least one pressed bevel is present at the at least one side edge of the panel and optionally wherein at least one seam is present in the at least one core layer in a region, preferably substantially, below the at least one pressed bevel. Preferably, the at least one seam is an at least partially, preferably substantially, more preferably entirely, sealed slit. With this decorative panel the advantages as listed above in relation to the method according to the present invention apply mutatis mutandis to the panel. In particular, the seam can provide strength for the, preferably complementary, coupling structures. Further, presence of the seam prevents the occurrence of rebound of the material of the panel and reduces height differences between pressed bevels of adjacent panels, thereby contributing to the visual effect of the adjacent panels. Also, the decorative panel has a lower CO2-footprint compared to known panels. Further, the seam allows the material of the panel to bear lower internal stresses due to applying a pressed bevel, than a panel not having such a seam. The presence of the seam, therefore, can reduce the risk of deforming the bevel and/or (partial) cracking of the panel. Particularly, the latter risk may be reduced since the slit forms the basis to accommodate for the displacement of material during formation of the bevel and as such to form the seam.

Preferably, the seam or slit at least partially overlaps, in particular as seen in a top view, with at least part of the pressed bevel. Said at least partial overlap of the slit or seam and the pressed bevel allows to optimally accommodate the deformed material.

Typically, the panel is produced via the method according to the invention. With this decorative panel the advantages as listed above in relation to the method according to the present invention may be realized and which advantages are here also included in relation to the decorative panel according to the present invention and which advantages are here copied in by reference.

In an embodiment, the at least one core layer comprises at least one thermoplastic composite material. Said material contributes to malleability of the panel, which is particularly beneficial for locally deforming of the panel.

Typically, the at least one core layer, preferably the thermoplastic composite comprised within said core layer, comprises at least 20%, preferably at least 50%, by weight of at least one mineral material and/or 15 to 40% by weight of thermoplastic or thermosetting material. Said thermoplastic composite comprises preferably at most 80%, more preferably at most 75%, more preferably 60-73% of at least one mineral material. Said weight percentage of mineral material make the core layer relatively resistant to heat, while still allowing deformation of side edge such that a pressed bevel can be formed. It is further conceivable that at least 50% by weight is a mineral material which makes it relatively resistant to heat, while still allowing deformation. This is in particular interesting when applying a texture in, for example, a PVC composition comprising at least 40%, more preferably at least 50%, most preferably at least 60% of mineral filler such as limestone. It is conceivable that other ranges are applied more suitable for higher filler ratios and/or thermoplastics with a differing Tg, such as PP, PET and/or PETg.

The thickness of the panel, and in particular the thickness of the core layer is preferably at most 6 mm, more preferably at most 5 mm. In a preferred embodiment, the panel comprises at least one core layer having a maximum thickness of 8 mm, more preferably 6 mm, or most preferably 4 mm.

It is conceivable that the density of said at least one core layer is preferably in the range of 700 to 2100 kg/m3, more preferably 700 to 1400 kg/m3 in the case of decorative wall or ceiling panels, more preferably 1400 to 2100 kg/m3 in the case of decorative floor panels. It is also conceivable that the panel comprises multiple core layers with different densities, such as a first core layer having a density of 700 to 1400 kg/m3, more preferably 900-1200 kg/m3, and a second core layer having a density of 1600 to 2100 kg/m3, more preferably 1700-2000 kg/m3.

It is conceivable that the at least one core layer is preferably an extruded core layer. The panel according to the present invention is preferably an extruded panel. It is imaginable that the panel is made via co-extrusion. In a possible embodiment, the core may comprise at least a natural material, a mineral material, a thermoplastic or thermosetting material, or a combination thereof. The natural material may comprise wood, engineered wood, a fibreboard such as medium-density fibreboard (MDF) or high-density fibreboard (HDF), green fibreboard, mycelium, and the like. The mineral material may comprise magnesium oxide (MgO), magnesium carbonate, magnesium chloride (MgCl), magnesium oxychloride (MOC), magnesium oxysulfate (MOS), Aluminium Trihydroxide (ATH), Magnesium Dihydroxide (MDH), phosphates, phosphinates, and/or phosphonates. It is also conceivable that the mineral material may comprise calcium carbonate (CaCO3), chalk, clay, calcium silicate, talc, and/or any other mineral material suitable for use in manufacturing decorative floor or wall panels. The use of at least one mineral material in the core layer is conceived to impart sufficient rigidity thereby ensuring dimensional stability of the panel.

The thermoplastic material may comprise of at least a polyvinyl chloride (PVC), polystyrene (PS), polyethylene (PE), polyurethane (PU), polyethylene terephthalate (PET), polyethylene terephthalate glycol (PETg), acrylonitrile butadiene styrene (ABS), polypropylene (PP), phenolic, melamine or formaldehyde resins and/or any other thermoplastic or thermoplastic material suitable for use in manufacturing decorative building panels or floor panels. The use of at least one thermoplastic or thermosetting material in the core layer is conceived to impart flexibility characteristics to the floor panel, for example when flexibility is required to achieve engagement of a locking mechanism. The core layer may also comprise a combination of any of the materials previously mentioned. It is conceivable that the composite material comprises at least 20% by weight of mineral material and/or 15%-40% by weight of thermoplastic or thermosetting material, more preferably at least 50% by weight of a mineral material, most preferably at least 70% by weight of a mineral material. This range is found to secure sufficient stability and strength of the core layer while also allowing for flexibility thereof and improving temperature resistance as well.

Optionally, the at least one core layer has a Vicat softening temperature of at least 60 degrees Celsius. Preferably, the at least one decorative top layer has a Vicat softening temperature of at most 70 degrees Celsius and/or wherein the Vicat softening temperature of the at least one core layer is at least 10 degrees Celsius higher than the Vicat softening temperature of the at least one decorative top layer. The panel comprises at least one decorative top layer. The level of deformability of said layer is often higher after applying the heat and/or pressure relative to the deformability of the core layer. The difference in Vicat softening temperature between the decorative top layer and the core layer allows for a controlled deformation of the core layer, in particular when heated, while preventing damage to the decorative top layer. It was surprisingly found that the Vicat softening temperature of the decorative top layer and/or the core layer Vicat was sufficient to soften the material of the panel to allow for deformation, while preventing melting, burning, and/or structural weakening of the panel.

Optionally, the at least one core layer comprises at least one thermoplastic composite material, preferably at least one partially foamed thermoplastic composite material having a Vicat softening temperature of at least 60 degrees Celsius, possibly at least 65 degrees Celsius, further possibly at least 70 degrees Celsius or at least 75 degrees Celsius. It is conceivable that the core layer comprises a thermoplastic composite material that is designed to have a Vicat softening point, and as found by experimentation therefore a Tg, that is at least 10 C higher than the at least one decorative top layer and/or the transparent wear layer.

Optionally, the upper surface of the panel comprises a surface structure with a texture depth less than the total thickness of the decorative top layer. The surface structure may comprise a tactile texture of at least 0.1 mm depth, preferably at least 0.2 mm depth, preferably at least 0.25 mm depth and at most 0.5 mm, preferably at most 0.45 mm, most preferably at most 0.4 mm depth.

The surface structure preferably has a maximum texture depth which is less than the total thickness of the decorative top layer and/or at least one bevel has a minimum depth of which is greater than the total thickness of the decorative top layer. Preferably, at least one surface of the panel comprises a surface structure wherein the maximum texture depth of the surface structure is less than the total thickness of the decorative top layer and/or the panel, preferably at least one edge of the panel, comprises at least one bevel wherein the minimum depth of at least one bevel is greater than the total thickness of the decorative top layer.

Typically, at least one decorative top layer may comprise at least one décor layer and/or at least one transparent wear layer. At least one decorative top layer may comprise at least one layer selected from the group of: a PVC decorative film, a PP decorative film, a PE decorative film, a PET decorative film, a PET-glycol decorative film, a modified PET decorative film, a modified PP decorative film, a digitally printed visual, a flexible ceramic, stone veneer and/or a wood veneer. It is also imaginable that at least one decorative layer comprises a decorative print which is printed directly on the upper core surface of the core layer and/or on a carrier foil.

The decorative top layer may also comprise at least one electromagnetically-cured (EMR) coating, preferably at least one UV-, EB-and/or excimer-cured coating. Said decorative top layer and/or the core layer can have sufficient flexibility at elevated temperatures to be deformed by the bevelling section, comprising at least one surface pressing structure, preferably a mechanical roller, and at least one back support structure.

Optionally, at least one decorative top layer is provided or attached to the top surface of the core layer. In such instance, the decorative top layer may also be referred to as décor layer or decorative layer, decorative surface, print layer, or a digitally printed layer. At least one decorative top layer may for example be a veneer layer, such as but not limited to wood veneer, a stone veneer, a flexible stone veneer, a flexible tile, and/or a natural veneer layer. The decorative top layer may for example comprise a flexible ceramic tile. The decorative top layer preferably comprises cellulose, fibrous, or paper layer having a decorative image or pattern that is provided via digital printing, laser printing, inkjet printing, rotogravure printing machine, electronic line shaft (ELS) rotogravure printing machine, automatic plastic printing machine, offset printing, flexography, or rotary printing press. Preferably, at least one decorative top layer is a flexible paper or foil that can be used with roller press or lamination machines which requires that the flexible paper is rollable, pliable, or roller-compatible. Preferably, the thickness of at least one decorative top layer is in the range of 0.05 mm and 0.10 mm, for example substantially 0.07 mm.

It is also conceivable that the at least the decorative top layer and/or the core layer, therefore are optionally sufficiently flexible at elevated temperatures to be deformed, for example, by a surface pressing structure, which may be a mechanical roller or similar device. The material may have enough give to be pressed into the desired bevel shape without cracking or breaking. Said pressing means is configured to apply pressure in such a manner as to form a rounded or bevelled edge. It is conceivable that said at least one surface pressing structure consists of at least one surface pressing device and at least one back support device, such as a roller.

The at least one decorative top layer preferably comprises at least one décor layer and/or at least one protective layer. It is conceivable that at least one décor layer is attached to said core layer, if applied. It is also conceivable that the décor layer is a print layer. It is also conceivable that at least one decorative layer is a print layer, in particular a digital print layer. It is conceivable that the print layer, such as a rotogravure print or digital print layer, further comprises at least one resin allowing thermolamination between said print layer and said at least one protective layer, such as a transparent wear layer. The décor layer may also form integral part of the core layer. In a beneficial embodiment of the panel, at least part of the upper surface of the core layer is provided with at least one decorative pattern or decorative image. It is for example possible that such decorative image or pattern is provided via printing, for example via digital and/or inkjet printing. It is also possible that at least one decorative pattern is formed by relief provided in the upper surface of the core layer or panel. It is also conceivable that the décor layer or decorative layer is a separate layer, for example a high-pressure laminate (HPL), a veneer layer, a directly laminated paper layer, and/or a ceramic tile. In a preferred embodiment, at least one decorative layer comprises a thermoplastic film or a ply of cellulose. It is for example possible that the décor layer comprises a plurality of impregnated layers containing lignocellulose but also a wood veneer, a thermoplastic layer, a stone veneer, a veneer layer or the like and/or a combination of said materials. The veneer layer is preferably selected from the group comprising of wood veneer, cork veneer, bamboo veneer, and the like.

Other materials such as ceramic tiles or porcelain, a real stone veneer, a rubber veneer, a decorative plastic or vinyl, linoleum, and laminated decorative thermoplastic material in the form of foil or film. The thermoplastic material can be PP, PE, PET, PETg, PVC, modified PET, modified PP, and the like. The design of the decorative layer can be chosen from a design database which includes digitally processed designs, traditional patterns, pictures or image files, customized digital artworks, randomized image pattern, abstract art, wood-patterned images, ceramic or concrete style images, AI-generated or user-defined patterns. The designs can be printed or reproduced using laser printers, inkjet printers, or any other digital printing means including the conventional printing methods. Various types of inks can also be used to suit the design needs of the décor layer. Preferably, the ink used during the printing method comprises properties such as but is not limited to waterproofness, lightfastness, acid-free, metallic, glossy, sheen, shimmering, or deep black, among others. It is desirable that the decorative layer is visually exposed by the coating layer being a substantially transparent coating layer. The décor layer may comprise a pattern, wherein the pattern is printed via digital printing, laser printing, inkjet printing, rotogravure printing machine, electronic line shaft (ELS) rotogravure printing machine, automatic plastic printing machine, offset printing, flexography, or rotary printing press.

It is also conceivable that the decorative top layer comprises at least one décor layer and at least one base coating layer. In a further embodiment, the panel comprises at least one base coating layer which covers at least part of the upper surface of the décor layer. In case the decorative top layer also comprises at least one wear layer, the base coating layer is preferably provided on an upper surface of the wear layer. The base coating layer is applied to protect the panel, and in particular the decorative top layer, during further processing, for example during cutting, sawing, punching, profiling, edging and/or bevelling of the panel. The base coating layer is preferably applied prior to the chamfer(s) are provided and/or prior to profiling of the panel. The base coating layer is preferably substantially transparent or translucent. The décor layer can be better observed. The base coating layer can for example be formed by a substantially transparent primer. The base coating layer can also be formed of any of the coating as described for the present invention for forming the at least one coating layer. The application of at least one base coating layer to the upper surface of the décor layer prior to steps of cutting, profiling and/or bevelling can contribute to the reduction of resistance between the cutting tools and the floor panel during the cutting, profiling and/or bevelling step. This can prevent that a white line is forming in the panels and may also reduce irregularities in the cut line between adjacent panels.

Optionally, at least one first bevel is present at the at least one first side edge of the panel and wherein at least one first seam is present in the at least one core layer in a region below the at least one first pressed bevel and wherein at least one second pressed bevel is present at the at least one second side edge of the panel and wherein at least one second seam is present in the at least one core layer in a region below the at least one second pressed bevel. Preferably, the at least one first side edged and the at least one second side edge are oppositely arranged. This may contribute to an enhanced visual effect of the panel.

In an embodiment at least one bevel has a depth greater than the total thickness of the decorative top layer. Said depth contributes to a visual effect of the panel.

The panel may be a floor, wall or ceiling panel, but may also be a decorative panel or a building panel. The panel according to the present invention preferably comprises a surface structure. Said surface structure can for example comprise an embossing (in register) structure and/or at least one bevel. It is for example imaginable that at least one bevel is provided on at least one side edge of the panel, in particular at least one lateral side edge. It is also imaginable that at least one panel comprises two opposing bevels, preferably provided at two opposing lateral side edges. At least one bevel can for example have a linear shape such that the bevels of at least two adjacent panels form a V-shape. In another embodiment at least one bevel has a convex shape such that the bevels of two adjacent panels form a U-shape. In another embodiment at least one bevel has a concave shape, such that the bevels of adjacent panels form a curved V-shape.

Optionally, at least one bevel has an outer surface that is shaped cross-sectionally as an arc of a circle and/or a repeating irregular pattern. Said shape of the outer surface contribute to a visual effect of the panel. Other possible bevels may include, square bevels. However, also V-shaped bevels and/or U-shaped bevels are imaginable. V-shaped bevels can enclose an angle of more than 5 degrees, for example in the range of 35 degrees to 60 degrees, and preferably approximately 45 degrees.

The angle can for example range from 2 degrees to 5 degrees, preferably from 4 to 15 degrees, and even more preferably 6 to 9 degrees. The depth of at least one bevel can for example range from 0.1 mm to 0.55 mm, from 0.2 mm to 0.35 mm, and more in particular from 0.5 mm to 3 mm, and even more in particular from 1.5 mm to 2.5 mm. U-shaped bevels can for example define a half-circle. It is alternatively also imaginable that at least one panel comprises at least one irregular or irregularly shaped bevel. It is likewise conceivable that at least part of the upper surface of the bevel forms an angle with the top surface of the panel which is also pressed.

The panel may have stretching of a maximum of 0.2% and a length variation of the panel, in particular a horizontal projected length variation between two opposing pressed bevels, is smaller than L2max−L2min=[arccosine(H2min/R)−arccosine(H2max/R)] for (H 2,max−H2,min)<0.1 mm. The panels may be produced such that an absolute projected vertical height difference between a bevel edge located on a side surface of a first panel and a bevel edge located on a side surface of a second panel is at most 0.05 mm. A standard deviation of projected vertical heights of a plurality of pressed bevels of different panels is expressed by s, and wherein this s is less than or equal to 0.036 mm. A length deviation between two opposing pressed bevels, in particular a deviation of projected horizontal length of a bevel, ranges between +0.5% to −0.5% of a predefined length between said bevels.

The method may further include the step of profiling and/or edging at least one side edge of at least one laminated panel. It is for example imaginable that the step comprises the provision of coupling elements or coupling parts, preferably complementary coupling elements or coupling parts. The core layer may optionally comprise complementary coupling parts. The core could for example comprise at least one pair of opposite side edges which are provided with complementary coupling parts. The complementary coupling parts, if applied, are typically configured for interconnecting adjacent panels. Typically, at least one pair of opposite side edges of the core layer is provided with complementary coupling parts. For example, the core layer comprises at least one pair of complementary coupling parts on at least two of its opposite side edges. Said coupling parts may for example be interlocking coupling parts configured for mutual coupling of adjacent panels in multiple directions. Preferably, said interlocking coupling parts provide locking in both horizontal and vertical directions. Any suitable interlocking coupling parts as known in the art could be applied. For example, said interlocking coupling parts may be in the form of complementary tongue and groove, male and female receiving parts, a projecting strip, and a recess configured to receive said strip or any other suitable form. It is conceivable the complementary coupling parts require a downward scissoring motion when engaging, or are locked together by means of a horizontal movement. It is further conceivable that the interconnecting coupling mechanism comprise a tongue and a groove wherein the tongue is provided on one side edge of one pair of opposite side edges, and the groove is provided on the other side edge, or an adjacent side relative to that of the tongue, of the same pair of opposite side edges. Such design of coupling mechanism is well-known in the art and has proven highly suitable for panels for floor coverings such as a floating floor. In a further embodiment it is possible that the interconnecting coupling mechanism has an interlocking feature which prevents interconnected panels from any free movement (play). Such an interlocking feature may be a projection and a respective recess provided on the respective opposite side edges by which neighboring panels interlock with each other. It is conceivable for provisions of reinforcement in the interlocking coupling parts to improve strength and prevent breakage thereof during the installation of the panels. For example, the complementary or interlocking coupling parts may be reinforced with materials such as but not limited to fiberglass mesh, reinforcing sheets, carbon fibers, carbon nanotubes, ceramics, glass, arrays of metallic or non-metallic rods, or polymer compounds integrally formed in the core layer. It is also conceivable that a strengthening coat layer of micro or nanotechnology is added on the surface of the interlocking coupling parts. The panel according to the present invention and/or the panel obtained via the method according to the present invention is suitable for use in flooring, wall or ceiling coverings preferably featuring a locking mechanism.

As such a ‘floating’ covering can be assembled by interconnecting the individual panels with each other at all four sides, without the need for adhesives. It is possible that the method provides for the provision of a laminated board comprises a core layer and at least one decorative top layer, and that said board is cut into panels. The coupling parts can be provided on the panels.

Optionally, at least one first pressed bevel is provided at the at least one first side edge of the panel, and at least one second pressed bevel is present at the at least one second side edge of the panel, wherein the first and second side edges are oppositely arranged; characterised in that the design of the at least one first pressed bevel is distinct from the design of the at least one second pressed bevel, thereby facilitating the subsequent application of distinct interlocking mechanism designs on the respective first and second side edges of the panel. This configuration allows for the creation of panel systems where the interlocking mechanisms on opposing edges are specifically adapted to engage with complementary features on adjacent panels, providing enhanced flexibility in assembly and potentially unique coupling characteristics. Optionally, at least one first pressed bevel is present at the at least one first side edge of the panel, and at least one second pressed bevel is present at the at least one second side edge of the panel, wherein the first and second side edges are oppositely arranged; characterised in that the design of the at least one first pressed bevel is distinct from the design of the at least one second pressed bevel for aesthetic or visually pleasing purposes. This deliberate variation in bevel design on opposing edges can contribute to a unique visual effect when multiple panels are arranged, allowing for design flexibility and enhanced aesthetic appeal in the assembled covering by presenting distinct edge treatments.

The invention is further related to a device for producing at least part of a decorative panel comprising a bevel, in particular a floor, wall, or ceiling panel, in particular for carrying out one or more steps of the method steps according to the invention, comprising:
at least one conveyor for transporting a panel along a transport path, wherein the panel comprises at least one core layer and at least one decorative top layer, and upper surface and at least one pair of opposing edges, wherein the at least one core layer comprises at least one thermoplastic composite material;
at least one primary processing section arranged along the transport path, wherein the primary processing section is configured to provide at least one precut to at least part of at least one side edge of the panel and in particular of the at least one core layer;
at least one heating section arranged along the transport path downstream with respect to the at least one primary processing section and comprising at least one laser, wherein the heating section is configured for locally heating, using the at least one laser, a predetermined region of the upper surface of the panel along an outer edge;
at least one bevelling section arranged along the transport path downstream with respect to the heating section, comprising at least one pressing element configured for deforming, in particular impressing, at least part of the heated upper surface of the panel such that at least one pressed bevel is formed at the at least one side edge of the panel, in particular at least two pressed bevels formed at least two opposing edges of the panel;
at least one milling section arranged along the transport path downstream with respect to the at least one bevelling section, configured for milling the at least one side edge of the core layer such that at least one coupling structure is formed, said coupling structure comprising at least one tongue and/or at least one groove; wherein the at least one heating section and the at least one bevelling section are arranged such that the locally heating of the predetermined region and the deforming, in particular impressing, of the at least part of the heated upper surface of the panel are performed substantially simultaneously such that it allows to perform the method at a production speed of at least 30 meters per minute.

It is conceivable that the at least one primary processing section is arranged along the transport path downstream with respect to the at least one the heating section. Where throughout this document reference is made to a specific section of the device, such as the primary processing section, each section can alternatively individually be referred to as a specific structure, such as the primary processing structure. Yet, alternatively, each individual section of the device may comprise such a specific structure for carrying out the specific function associated to said section.

Preferably, the device is configured to run at a production speed of at least 30 meters per minute, preferably at least 60 meters per minute, and most preferably at least 90 meters per minute. With this device the advantages as listed above in relation to the method according to the present invention may be realized and which advantages are here also included in relation to the device according to the present invention and which advantages are here copied in by reference.

The milling section preferably comprises at least one milling element configured to remove or mill at least part of at least one side edge of the core layer. The milling element, such as a saw blade, is preferably at least partially arranged along the heating section and/or the beveling section such that milling of the panel can be performed before or after applying the pressed bevel. The coupling structures can enhance the coupling between adjacent panels and thereby accurately form a floor covering.

The device typically comprises a control unit configured to detect a position of the panel relative to one or more of the sections. The control unit can ensure that the steps performed at one or more of the sections can be synchronized and accurately performed.

Typically, the at least one primary processing section comprises at least one cutting structure configured for milling at least one slit into at least part of at least one side edge of the panel and in particular of the at least one core layer. It is also conceivable that the primary processing section comprises at least one milling structure. Preferably, the heating section is configured to heat an upper portion of the panel, in particular a thickness situated in range of 0.4 to 4 mm extending from an upper surface of the panel towards a bottom surface of the panel. Optionally, the heating section comprises a laser, a focused infrared heater, a heated roller, a narrow heated roller, a focused UV heating, a thermal radiation lamp, a focused hot air gun, or a combination thereof.

Usually, the device further comprises at least one aligning section comprising one or more aligning structures for aligning a panel along the transport path. Preferably, wherein the one or more aligning structures are at least partially formed by one or more chains, bands, rules, and/or pressing rollers. Said aligning section can at least partially overlap with one or more other sections.

It is imaginable that the device further comprises at least one cooling section arranged along the transport path downstream with respect to the primary processing section, in particular downstream with respect to the beveling section, wherein the cooling section is configured for cooling a panel having the at least one pressed bevel and/or wherein the cooling section is at least partially integrated with the bevelling section. Said cooling section can be at least partially integrated with the bevelling section such that the material of the panel is set into its new shape while preventing rebound.

A cooling system may be provided in a cooling section, for example a water-cooling system, can be applied for control of the extruder temperature. Water cooling system may be preferred over air cooling system, which is typical in conventional extrusion lines, as it provides a more consistent and uniform cooling since water is a better conductor of heat than air but is not easily affected by changes in ambient temperature and humidity.

Typically, the bevelling section comprises at least one surface pressing structure and at least one back support structure, a roller, or any combination thereof.

Preferably, the pressed bevel has an outer surface shaped cross-sectionally as an arc of a circle or a repeating irregular pattern.

The device optionally further comprises at least one welding section arranged along the transport path downstream with respect to the at least one bevelling section and upstream with respect to the at least one milling section, wherein the welding section is configured to seal an at least part of the at least one slit, in particular by applying an adhesive and/or a solvent, heat or pressure, to one or more inner sides of the slit, and/or wherein the welding section is arranged at least partially along the bevelling section such that at least part of the slit can be sealed during deforming, in particular impressing, at least part of the heated upper surface of the panel. It is imaginable that the welding section is configured to seal the slit by melting or fusing one or more edges of the slit, comprises a laser, a heated roller, a focused UV heating, a thermal radiation lamp, or a focused infrared heating, or any combination thereof.

The milling section is preferably further configured for milling the at least one second side edge of the core layer such that at least one second coupling structure is formed, in particular a to the coupling structure complementary coupling structure, wherein the complementary coupling structure comprising at least one tongue and/or at least one groove.

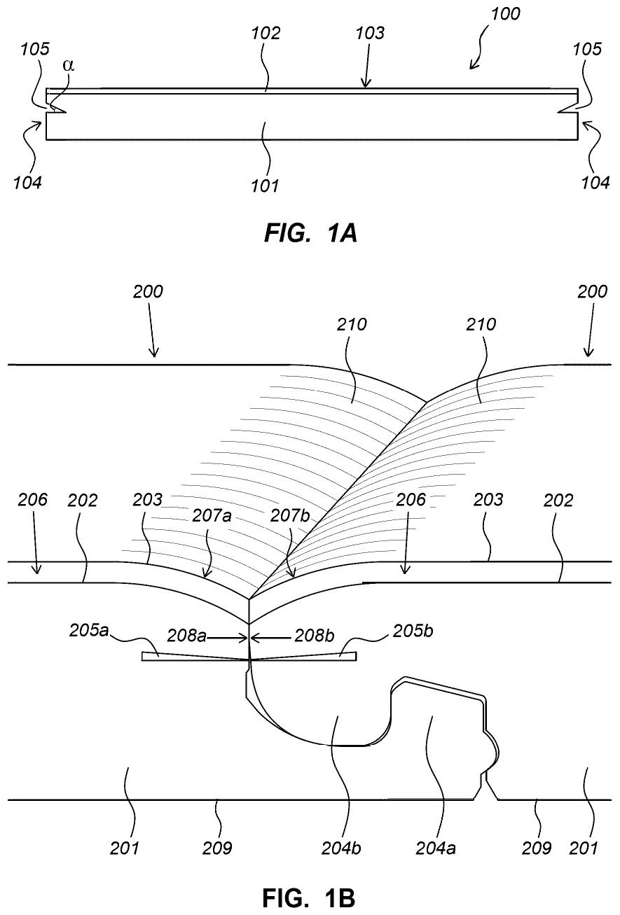

FIG. 1A shows a panel 100 having a core layer 101 and a decorative top layer 102. The panel 100 further has a pair of opposing side edges 104. In this embodiment, the opposing side edges 104 are provided with a slit 105. The slits 105 recede inwardly from a side edge 104. The slits 105 are beneficially arranged in the core layer 105, thereby allowing the decorative top layer 102 to extend over the panel in an uninterrupted manner, which contributes to an appealing visual effect. In this embodiment, the slits 105 have a triangular shape, which shape can optimally arrange the curve of the pressed bevel, in particular when the slits 105 have an angle a of preferably at least 5 degrees relative to the upper surface 103 of the panel 100. In other embodiments, it is conceivable to apply different shapes for the slits 105, depending for example on the type of material of the panel 100. The slits 105 can recede at least 0.2 mm into the core layer 101 such that a central region of the core layer 101 and/or the decorative layer 102 remains substantially unaffected. In FIG. 1A is shown that the slits 105 are arranged at opposing side edges 104 of a panel 100, in particular the opposing side edges of a short side of the panel, assuming that in this embodiment the panel 100 has a rectangular shape having two opposing long sides and two opposing short sides, wherein the long sides are located perpendicular to the short sides. Lastly, it is noted that the shown figures are not necessarily an indication of a (length) scale of the features shown in the figures.

FIG. 1B shows parts of two panels 200 in a mutually coupled stated. The panel 200 comprises a core layer 201 and a decorative top layer 202, 203, which is affixed to an upper surface of the core layer 201. The decorative top layer 202, 203 comprises a décor layer 202 and a wear layer 203 forming an upper surface of the panel 200. The décor layer 202 can contribute to an appealing visual effect of the panel 200, and the at least one wear layer 203 can protect the décor layer 202 from wear during use of the panel 200. The panel 200 can further comprise a surface structure 206 arranged on the upper surface of the panel 200. In this embodiment, the surface structure 206 is arranged on the upper surface of the core layer 201. The surface structure 206 may have a texture depth less than the total thickness of the decorative top layer 202, 203. The surface structure 206 may have a texture depth that exceeds the total thickness of the decorative top layer 202, 203. The panel 200 has at least two opposing side edges 208a, 208b. Said opposing side edges 208a, 208b comprise a coupling structure 204a, 204b, wherein said coupling structures 204a, 206b are complementary. The coupling structures 204a, 204b are formed by a downward tongue 204b, which at least partially encloses a downward groove, and an upward tongue 204a, which at least partially encloses an upward tongue. The downward tongue 204b can be at least partially positioned in the upward groove of an adjacent panel and the upward tongue 204a can be at least partially positioned into the downward groove of an adjacent panel in order to mutually couple adjacent panels. The panels 200 are respectively further provided with a pressed bevel 207a, 207b. The core layer 201 of the panel 200 optionally further comprises a seam 205a, 205b, which is located below the pressed bevel 207a, 207b. Rather than the slit 105 provided to the panel 100 as shown in FIG. 1A, the seam 205a, 205b as shown in the panels 200 of FIG. 1B can be understood as a sealed slit 105. The seam 205a, 205b is in particular a result of pressing a part of an upper surface of the side edge of the panel 200 towards a lower surface 209 of the panel 200. In this embodiment a predetermined region 210 is locally heated and then deformed or pressed. The slit which recede inwardly from a side edge 208a, 208b of a panel 200 is then at least partially sealed due said pressing. The slit allows the material of the upper surface of the side edge 208a, 208b of the panel to displace, thereby forming a pressed bevel 207a, 207b. The shape of the slit can contribute to a shape of the an outer surface of the pressed bevel 207a, 207b. In this embodiment, the pressed bevel 207a, 207b has an outer surface that is shaped cross-sectionally as an arc of a circle.

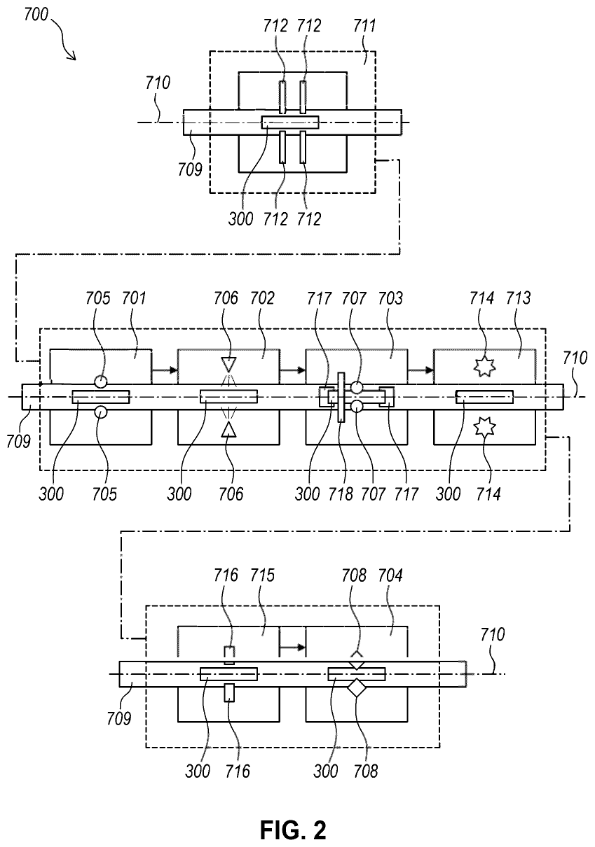

FIG. 2 schematically shows the device 700 for producing a decorative panel 300 comprising a pressed bevel and a mutually coupling profile. The device 700 comprises multiple sections in order to apply at least a pressed bevel. Along said sections at least one conveyor 709 is arranged. The at least one conveyor 709 is configured for conveying at least one panel 300 along a transport path 710. The panel 300 comprises at least one core layer and at least one decorative top layer and at least one pair of opposing edges. The at least one conveyor 709 transports the panel 300 firstly to a primary processing section 701. Said primary processing section 701 comprises a cutting structure 705, which is configured to precut a side edge of said at least one panel, optionally to provide additionally at least one slit in a part of a side edge of the panel 300. In general, the slit is applied to opposing side edges of the panel 300. In the shown embodiment, the panel 300 is transported in its longitudinal direction, which allows to provide the slits on the long sides of the panel 300. It is, however, also conceivable that the panel 300 is arranged perpendicular to the arrangement shown in FIG. 2. In that configuration, the device 700, in particular the primary processing section 701, in particular cutting structure 705 can precut at least one side edge of the panel, optionally provide at least one slit into at least part of at least one side edge of a short side of the panel 300. The slit is preferably arranged in the core layer of the panel 300. In this embodiment, the device 700 comprises at least one aligning section 711 comprising one or more aligning structure 712. Said aligning structures 712 can align the panels 300 that are transported by the conveyor 709 along the transport path 710. This allows to optimize the performance of the steps performed in the other sections. For example, in order to precut the at least one panel and/or provide at least one slit, it is beneficial to accurately position a panel with respect to the cutting structure 705. It is also conceivable that along the transport path 710 multiple aligning sections 711 and/or aligning structures 712 are arranged. This contributes to optimally positioning the panel for each section. Downstream along the transport path relative to the primary processing section 701 at least one heating section 702 is arranged. The at least one heating section 702 can locally heat at least an upper portion of the upper surface of the panel 300, in particular along an outer edge. In this embodiment, the part of the panel 300 that is heated overlaps preferably with a part of said at least one slit. The heating section 702 comprises a heating element 706 for at least heating the upper portion of the panel 300. The heating section 702 comprises at least two heating elements 706 in order to heat at least parts of two opposing side edges. Downstream along the transport path relative to the heating section 702 a bevelling section 703 is arranged. In this embodiment, the bevelling section 703 comprises at least two pressing elements 707. Said pressing elements 707 can deform at least a part of the heated upper surface of the panel, preferably along at least one edge of said panel 300. Said deformation allows to form a pressed bevel at the side edges of the long sides of the panel 300. The bevelling section comprises at least one surface pressing structure 718 and at least one back support structure 717, which contribute to optimally arrange the pressed bevel. Downstream relative to the bevelling section 703, a cooling section 713 is arranged along the transport path 710. The cooling section 713 can cool at least part of the panel 300 having one or more pressed bevels. In another embodiment, it is conceivable that the cooling section 713 is at least partially integrated with the bevelling section 703. This allows to minimize the rebound of the material of the panel 300. Therefore, it is preferred to arrange the cooling section 713 upstream along the transport path 710 relative to the milling section 704. Further, the device 700 can provide a welding section 715, which is in a preferred embodiment, arranged along the transport path 710 between the bevelling section 703 and the milling section 704. The welding section 715 is configured to seal a at least part of the at least one slit of the panel 300, when applied. In another embodiment, the welding section 715 can be at least partially arranged along the bevelling section 703. This allows to seal at least part of the slit when the pressed bevel is applied. The welding section 716 comprises one or more sealing elements 716 such as, but not limited to, a laser, a focused UV heating, or a focused infrared heating. After providing the pressed bevel on the side edges of the panel 300, a coupling structure can be formed on the side edges of the panel 300. The coupling structure can be formed in the milling section 704. In general this is done by one or more milling elements, such as saw blades 708. In this embodiment, the milling section 704 is arranged downstream with respect the bevelling section 703. It is also conceivable that the milling section 704 is located upstream of the bevelling section 703 or the primary processing section 701. In another embodiment, the milling section 704 can be arranged at a distance from one or more of the other sections, in particular wherein the milling section 704 is not directly arranged along the transport path 710, for example when the milling section 704 is arranged in a different factory or plant.

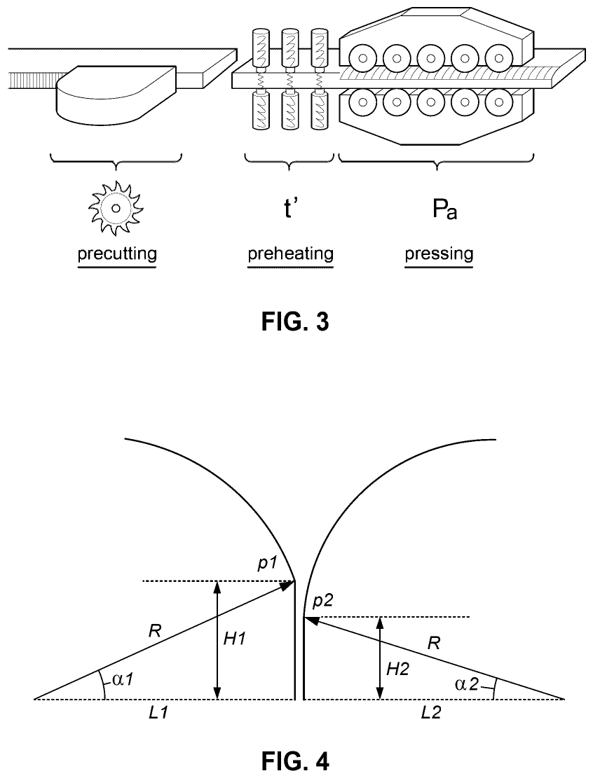

FIG. 3 illustrates an embodiment of the method according to the present invention, wherein the optional precutting step involves milling, cutting, removing material from, and/or forming at least one slit in at least a portion of at least one side edge of the panel, specifically within the at least one core layer. In this embodiment, the optional at least one slit is formed at an inclined angle relative to the upper surface of the panel. The inclination angle may be at least 5 degrees, preferably at least 10 degrees, more preferably 30 degrees, and in some cases up to 30 or 40 degrees.

FIG. 3 further shows the deforming step wherein at least part of a predetermined region of the panel is subjected to a mechanical forming process involving preheating at temperature t′ and pressing at pressure Pa. This predetermined region overlaps at least partially with the slit, when applied. The overlap between the deformed zone and the optionally applied preformed slit allows for localized material displacement, which enables the formation of a pressed bevel or recessed surface structure while minimizing stress across the panel. In the shown embodiment, the deforming step is performed by pressing by using rolls. Before pressing, the panel is (pre)heated in order to increase the temperature for deforming.

In an embodiment where the preheating section comprises one or more lasers, said lasers may be said to project a heating area onto the panel, forming the heated section of the panel, and the heating area may be elongated. The heating area may have a length of at least 150 mm, more preferably at least 200 mm, and most preferably at least 250 mm. In certain configurations, heating area may have a length of up to 350 mm, more preferably up to 400 mm, most preferably up to 450 mm. Such lengths for the heating area may contribute to production speeds of at least 30 meters/minute, more preferably at least 60 meters/minute. The heating area may have a width. In a preferred embodiment, the width is at least 0.5 mm, ideally at least 1 mm. In a further preferred embodiment, the width is at most 4 mm, ideally at most 3 mm. Said configurations allow sufficient dwell times for the heating area to achieve sufficiently high temperatures for thermal deformation.

In a further embodiment where the preheating section comprises one or more lasers, locally heating the panel may allow for heating said edge region to a temperature of at least 80 C, more preferably at least 90 C, most preferably at least 100 C and at most 170 C, more preferably at most 160 C, most preferably at most 150 C at a surface of the heated region. In a particularly advantageous embodiment, said laser heating heats said edge region to a temperature in a range of 110-140 C before deformation.

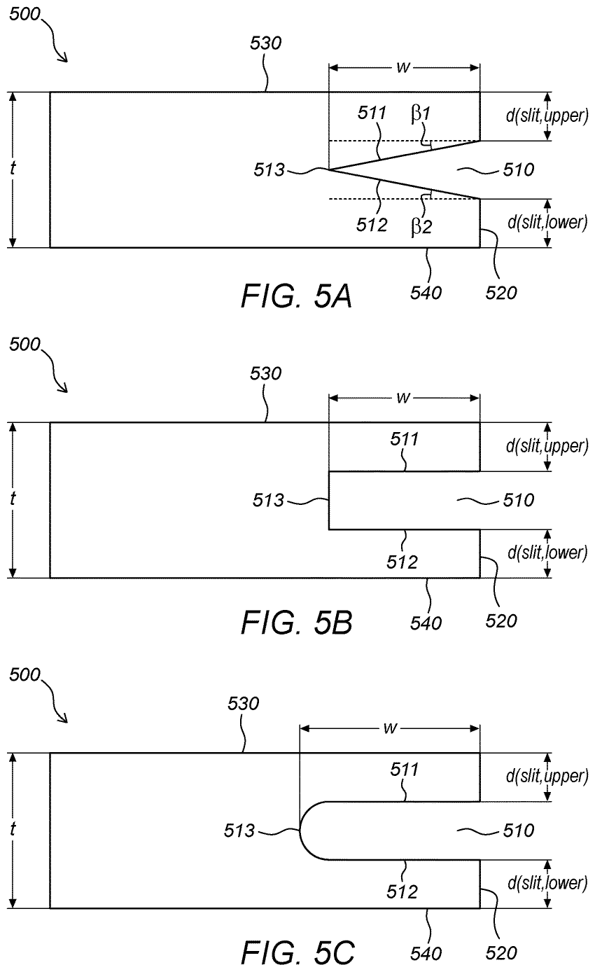

FIG. 4 illustrates a cross-sectional view of two adjacent pressed bevels, each defined by their respective projected bevel heights, denoted as H1 and H2. The figure also includes an arc segment representing a portion of a circle with a radius R, along with cut-off points p1 and p2, which indicate the outermost edges of the bevels following profiling. Additionally, the geometry of each bevel is characterized by corresponding angles α1 and α2, associated with the curvature or slope of the bevel surfaces.

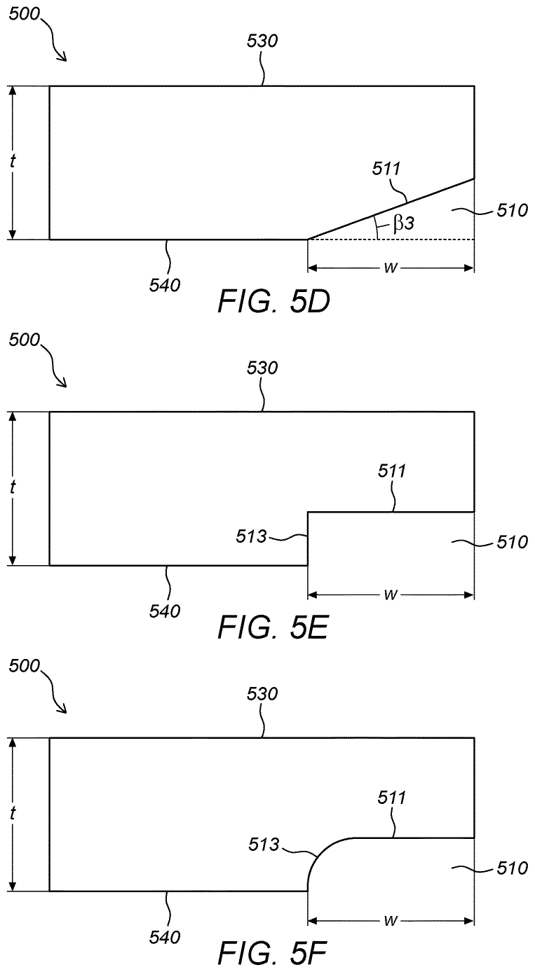

FIGS. 5a-5f illustrates another possible embodiments of the invention, wherein the panel 500 is provided with different slits. The panel 500 as shown in FIG. 5a has a total thickness t and includes at least one slit 510 formed at a distal edge 520 of the panel. Said slit includes an upper landing 511, may be aligned parallel to the upper surface 530 or oriented at an angle β1 relative to that surface, and/or a lower landing 512, which may likewise be provided parallel to the bottom surface 540 of the panel or, alternatively, angled at β2 with respect to bottom surface 540. Both landings intersect the distal edge 520 at respective depths—d(slit, lower) and d(slit, upper)—with the vertical distance from the upper surface 530 to d(slit, upper) defining the upper slit thickness. An interior wall 513, forms the boundary between the upper and lower landings and may be angled (FIG. 5a), straight (FIG. 5b), or curved (FIG. 5c). The interior wall 513 may connect the upper and lower landings either directly or indirectly and is preferably the innermost, most proximal boundary of the slit. The horizontal distance from the interior wall 513 to the distal edge 520 is referred to as the slit width w. The slit may also comprise of one upper landing, such that of a straight upper landing at an angle β3 with respect to bottom surface 540 (FIG. 5d), a straight upper landing with an interior wall (FIG. 5e), and a curved upper landing (FIG. 5f). The (predetermined) region defined by the upper slit thickness may at least partially include one or more of the following layers: decorative top layer, transparent wear layer, any coating or reinforcing layers, and/or a portion of the core layer.

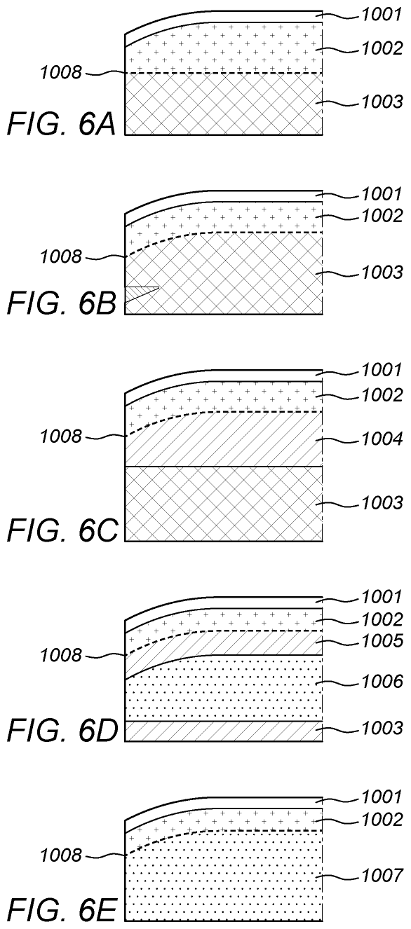

In one embodiment, shown in FIG. 6(a), the panel comprises a single solid core 1003 (preferably made of or at least mostly comprising SPC) and a decorative top layer comprising a film 1008, at least one plasticized wear layer 1002, and at least one lacquer coating 1001. During the bevelling process, the solid core 1003 and the décor film remain non-deformed, whereas the plasticized wear layer 1002 and lacquer coating 1001 are locally mechanically deformed to create the bevel profile. This superficial compression configuration is particularly suited for thinner SPC products where core integrity must be maintained.

In another embodiment, shown in FIG. 6(b), solid core 1003 is deformed mechanically alongside the entire decorative top layer. To accommodate the displacement of the solid thermoplastic mass and prevent surface irregularities, a mechanical slit is provided in at least one side edge of the core 1003. Said slit allows the material to deform more readily under heat and pressure without compromising the underlying core material.

In a further variation of the solid core design, the core and decorative layers are deformed without the provision of a slit. This embodiment relies on the inherent malleability of the thermoplastic composite when heated above its Vicat softening temperature to accommodate local displacement within the material's own volume.

In one alternative embodiment, shown in FIG. 6(c), the decorative top layer comprises at least one flexible layer 1004. Said flexible layer 1004 comprises preferably a vinyl, plasticized vinyl, and/or compressible vinyl. Said flexible layer 1004 preferably has a thickness of 0.1-0.6 mm, more preferably at 0.2-0.5 mm. Said flexible layer 1004 is preferably provided underneath at least one décor layer 1008 and/or above a solid core 1003. Alternatively, said flexible layer 1004 may be transparent and provided on top of at least one décor layer 1008. The flexible layer 1004, décor film 1008, wear layer 1002, and/or coating 1001 may be mechanically deformed. The flexible layer's 1004 low Vicat softening point allows deformation at temperatures that preferably do not affect the structural, solid core 1003.

In a further embodiment, comprising at least one decorative top layer comprising at least one flexible layer 1004, the panel utilizes at least one low-density foamed core 1006. The foamed core 1006, flex layer 1004, and decorative top layers are all mechanically deformed. The foamed core 1006 functions specifically as a compressible material, which advantageously allows for the displacement of material during bevelling up to extreme depths without the necessity of a separate slit.

One further advantageous embodiment, shown in FIG. 6(d), comprises a first solid lower core 1003 and a second low-density foamed upper core 1006. Said solid lower core 1003 remains non-deformed to provide rigidity, allowing the panel to still pass commercial levels of castor chair tests (25,000 R), while the foamed upper core 1006, flex layer 1004, and decorative top layers are deformed. The upper foamed layer 1006 provides thereby necessary compressibility to absorb the material displaced by the mechanical bevelling rollers. In this embodiment, an optional slab layer may be included in between the foamed core layer 1006 and the flex layer 1004 and/or decorative top layers.

In another embodiment, shown in FIG. 6(e) the at least one panel comprises at least one high-density foamed core 1007 of 1400-1700 kg/m³ (LDSPC) and at least one decorative top layer comprising at least one décor film 1008, at least one wear layer 1002, and/or at least one coating 1001. Despite its higher density the foamed structure still provides sufficient internal volume to accommodate material displacement during the pressing of the bevel. Alternatively, said panel further comprises further at least one solid, non-deforming lower core and a high-density foamed upper core. In this embodiment, it is preferred that said upper core and the decorative top layer are deformed, while the solid lower core maintains the panel's dimensional stability and strength. This configuration allows for a deep, precise bevel while ensuring the bottom surface of the panel remains unaffected by the mechanical forces during the at least one bevelling step.

### CLAUSES

The present disclosure further presents the following clauses:
1. Method for applying a pressed bevel to a decorative panel, comprising the steps of:
a) providing at least one decorative panel, said panel comprising at least one core layer and at least one decorative top layer, and an upper surface and at least one pair of opposing side edges;
b) precutting at least part of at least one side edge of the panel and in particular of the at least one core layer;
c) locally heating a predetermined region of the upper surface of the panel along an outer edge;
d) deforming at least part of the heated upper surface of the panel, in particular the predetermined region, such that at least one pressed bevel is formed at the at least one side edge of the panel, in particular formed along a side edge, preferably at at least one short side edge and/or at least one long side edge of the panel;
e) subjecting the at least one side edge of the core layer to a milling process wherein at least one coupling structure is formed, said coupling structure comprising at least one tongue and/or at least one groove.
2. Method according to any of the preceding clauses, wherein the steps are subsequent steps.
3. Method according to any of the preceding clauses, wherein steps c) and d) are performed substantially simultaneously.
4. Method according to any of the preceding clauses, wherein step (a) is preferably performed at room temperature, wherein the room temperature is preferably within a range of 15 degrees Celsius to 25 degrees Celsius.
5. Method according to any of the preceding clauses, wherein during step b)at least one slit is provided into at least part of at least one side edge of the panel and in particular of the at least one core layer, preferably wherein during step c) at least part of the predetermined region overlaps with at least part of the at least one slit.
6. Method according to clause 5, wherein the at least one slit is formed at an angle of at least 5 degrees, preferably at least 10 degrees, more preferably 30 degrees, even more preferably at most 30 degrees, and at most 40 degrees with respect to an upper surface of the panel.
7. Method according to any of the clauses 5 or 6, wherein during step (d) at least part of the predetermined region is deformed such that it overlaps with at least part of the at least one slit.
8. Method according to any of clauses 5 to 7, further comprising the step of sealing at least part of at least one slit, in particular prior to forming at least one coupling structure during step e).
9. Method according to any of clauses 5 to 8, wherein at least part of at least one slit is sealed during or after formation of at least one pressed bevel.
10. Method according to any of clause 8 or 9, wherein at least part of the sealing step is performed by using at least one laser, heated roller, or focused infrared heating and/or by applying a solvent and/or an adhesive to at least a part of an inner side of the slit.
11. Method according to any of clauses 5 to 10, wherein the location of at least part of the locally heated region overlaps with at least part of the position of the at least one slit.
12. Method according to any of clauses 5 to 11, wherein at least one slit is an uninterrupted slit.
13. Method according to any of clauses 5 to 12, wherein the slit of step b) has a rectangular, a square, a triangular, or a trapezoid shape.
14. Method according to any of clauses 5 to 13, wherein at least one slit extends at least 0.2 mm into the core layer, in particular at least 0.4 mm, more in particular at least 0.6 mm.
15. Method according to any of the preceding clauses, wherein step (d) is performed at room temperature, wherein the room temperature is preferably within a range of 15 degrees Celsius to 25 degrees Celsius.
16. Method according to any of the preceding clauses, wherein during step (d) at least part of the heated upper surface is deformed by pressing and/or rolling.
17. Method according to any of the preceding clauses, wherein at least one heating step is performed with at least one laser, focused infrared heater, heated roller, narrow heated roller, focused UV heating, thermal radiation lamp, focused hot air gun, or a combination thereof.
18. Method according to any of the preceding clauses, wherein deforming at least part of the heated upper surface is done by at least one bevelling section, comprising at least one surface pressing structure and at least one back support structure.
19. Method according to any of the preceding clauses, wherein locally heating of at least one predetermined region is performed such that at least a central region of the upper surface of the panel is substantially unaffected by the heating step, in particular wherein preferably only an upper portion and/or edge portion of the panel is heated, in particular up to a depth of 0.6 to 4 mm extending from an upper surface of the panel towards a bottom surface of the panel and/or a width of 0.5 mm to 6 mm measured from the outer edge of the panel.
20. Method according to any of the preceding clauses, further comprising at least one cooling step after step d).
21. Method according to any of the preceding clauses, wherein the at least one core layer comprises at least one thermoplastic composite material having a Vicat softening temperature of at least 60 degrees Celsius.
22. Method according to any of the preceding clauses, wherein the at least one decorative top layer has a Vicat softening temperature of at most 70 degrees Celsius and/or wherein the Vicat softening temperature of the at least one decorative top layer is at least 10 degrees Celsius lower than the Vicat softening temperature of the at least one core layer.
23. Method according to any of the preceding clauses, wherein the at least one decorative top layer is heated at a temperature of at least 5 °C to 10 °C, more preferably at least 10 °C to 15 °C, and most preferably at least 15 °C to 20 °C above the glass transition temperature of the core layer.
24. Method according to any of the preceding clauses, wherein the method is performed at a production speed of at least 30 meters per minute, preferably at least 60 meters per minute, and most preferably at least 90 meters per minute.
25. Method according to any of the preceding clauses, comprising the step of aligning the at least one decorative panel prior to the at least one milling and/or heating step.
26. Method according to any of the preceding clauses, comprising the steps of milling at least one first slit into at least part of at least one first side edge of the panel and in particular of the at least one core layer and least one second slit into at least part of at least one second side edge of the panel and in particular of the at least one core layer which opposes the first side edge, and locally heating at least two predetermined regions of the upper surface of the panel, wherein at least part of a first predetermined region overlaps with at least part of the at least one first slit and wherein at least part of a second predetermined region overlaps with at least part of the at least one second slit, and deforming at least part of the heated upper surface of the panel such that at least one first pressed bevel is formed at the at least one first side edge of the panel and at least one second pressed bevel is formed at the at least one second side edge of the panel.
27. Method according to clause 26, comprising the step of subjecting the at least two opposing side edge of the core layer to a milling process wherein complementary coupling structures are formed, wherein each coupling structure comprises at least one tongue and/or at least one groove.
28. Decorative panel produced by a method according to any of the preceding clauses.
29. Decorative panel, in particular a floor, wall or ceiling panel, comprising:
   at least one core layer; and
   at least decorative top layer,
wherein the panel comprises an upper surface and at least one pair of opposing side edges, wherein at least one side edge comprises at least one coupling structure, preferably wherein the at least two opposing side edges comprise complementary coupling structures each comprising at least one tongue and/or at least one groove; wherein at least one pressed bevel is present at the at least one side edge of the panel and/or wherein at least one seam is present in the at least one core layer in a region substantially below the at least one pressed bevel.
30. Panel according to clause 29, wherein the panel is produced via the method according to any of clauses 1-27.
31. Panel according to clause 29 or 30, wherein the at least one core layer comprises at least one thermoplastic composite material.
32. Panel according to any of clauses 29 to 31, wherein the at least one core layer comprises at least 20% by weight of at least one mineral material and/or 15-40% by weight of thermoplastic or thermosetting material.
33. Panel according to any of clauses 29 to 32, wherein the at least one core layer has a Vicat softening temperature of at least 60 degrees Celsius.
34. Panel according to any of clauses 29 to 33, wherein the at least one decorative top layer has a Vicat softening temperature of at most 70 degrees Celsius and/or wherein the Vicat softening temperature of the at least one core layer is at least 10 degrees Celsius higher than the Vicat softening temperature of the at least one decorative top layer.
35. Panel according to any of clauses 29 to 34, wherein the at least one core layer comprises at least one thermoplastic composite material having a Vicat softening temperature of at least 80 degrees Celsius and/or wherein at least part of the at least one decorative top layer has a Vicat softening temperature of at most 70 degrees Celsius.
36. Panel according to any of clauses 29 to 35, wherein the upper surface of the panel comprises a surface structure with a texture depth less than the total thickness of the decorative top layer.
37. Panel according to clause 36, wherein the surface structure may comprise a tactile texture of at least 0.1 mm depth, preferably at least 0.2 mm depth, preferably at least 0.25 mm depth and at most 0.5 mm, preferably at most 0.45 mm, most preferably at most 0.4 mm depth.
38. Panel according to any of clauses 29 to 37, wherein at least one decorative top layer may comprises a décor layer and/or a transparent wear layer.
39. Panel according to any of clauses 29 to 38, wherein at least one decorative top layer comprises a PVC, PP, PET, PETg, modified PP, or modified PET decorative film, a digitally printed visual, a flexible stone veneer, a flexible ceramic, or a wood veneer.
40. Panel according to any of clauses 29 to 39, wherein at least one first bevel is present at the at least one first side edge of the panel and wherein at least one first seam is present in the at least one core layer in a region below the at least one first pressed bevel and wherein at least one second pressed bevel is present at the at least one second side edge of the panel and wherein at least one second seam is present in the at least one core layer in a region below the at least one second pressed bevel.
41. Panel according to any of clauses 29 to 35, wherein at least one bevel has a depth greater than the total thickness of the decorative top layer.
42. Panel according to any of clauses 29 to 41, wherein at least one bevel has an outer surface that is shaped cross-sectionally as an arc of a circle and/or a repeating irregular pattern.
43. Panel according to any of clauses 29 to 42, wherein the stretching of the panel has a of maximum 0.2% and a length variation of the panel, in particular a horizontal projected length variation between two opposing pressed bevels, is smaller than L2,max−L2,min=[arccosine(H2,min/R)−arccosine(H2,max/R)] for (H2,max—H2,min)<0.1 mm.
44. Device for producing at least part of a decorative panel comprising a bevel, in particular a floor, wall, or ceiling panel, in particular for carrying out one or more steps of the method steps according to any of the clauses 1 to 27, comprising:
   at least one conveyor for transporting a panel along a transport path, wherein the panel comprises at least one core layer and at least one decorative top layer, and upper surface and at least one pair of opposing edges;
   at least one primary processing section arranged along the transport path, wherein the primary processing section is configured to provide at least one precut, in particular at least one slit into at least part of at least one side edge of the panel and in particular of the at least one core layer;
   at least one heating section arranged along the transport path downstream with respect to the at least one primary processing section, wherein the heating section is configured for locally heating a predetermined region of the upper surface of the panel along an outer edge, preferably wherein at least part of the predetermined region overlaps with at least part of the at least one slit;
   at least one bevelling section arranged along the transport path downstream with respect to the heating section, comprising at least one pressing element configured for deforming, in particular impress, at least part of the heated upper surface of the panel such that at least one pressed bevel is formed at the at least one side edge of the panel, in particular at least two pressed bevels formed at at least two opposing edges of the panel;
   at least one milling section arranged along the transport path downstream with respect to the at least one bevelling section, configured for milling the at least one side edge of the core layer such that at least one coupling structure is formed, said coupling structure comprising at least one tongue and/or at least one groove.
45. Device according to clause 44, wherein the at least one primary processing section comprises at least one cutting structure configured for milling at least one slit into at least part of at least one side edge of the panel and in particular of the at least one core layer.
46. Device according to clause 44 or 45, wherein the heating section is configured to heat an upper portion of the panel, in particular a thickness situated in range of 0.4 to 0.6 mm extending from an upper surface of the panel towards a bottom surface of the panel.
47. Device according to clause 46, wherein the heating section comprises a laser, a focused infrared heater, a heated roller, a narrow heated roller, a focused UV heating, a thermal radiation lamp, a focused hot air gun, or a combination thereof.
48. Device according to any of the clauses 44 to 47, wherein the device further comprises at least one aligning section comprising one or more aligning structures for aligning a panel along the transport path.
49. Device according to clause 48, wherein the one or more aligning structures are at least partially formed by one or more chains, bands, rules, and/or pressing rollers.
50. Device according to any of the clauses 44 to 49, wherein the device further comprises at least one cooling section arranged along the transport path downstream with respect to the primary processing section, in particular downstream with respect to the bevelling section, wherein the cooling section is configured for cooling a panel having the at least one pressed bevel and/or wherein the cooling section is at least partially integrated with the bevelling section.
51, Device according to any of the clauses 44 to 50, wherein the bevelling section comprises at least one surface pressing structure and at least one back support structure, a roller, or any combination thereof.
52. Device according to any of clauses 44 to 51, further comprising at least one welding section arranged along the transport path downstream with respect to the at least one bevelling section and upstream with respect to the at least one milling section, wherein the welding section is configured to seal a at least part of the at least one slit, in particular by applying an adhesive and/or a solvent to one or more inner sides of the slit, and/or wherein the welding section is arranged at least partially along the bevelling section such that at least part of the slit can be sealed during deforming, in particular impressing, at least part of the heated upper surface of the panel.
53. Device according to clause 52, wherein the welding section is configured to seal the slit by melting or fusing one or more edges of the slit, comprises a laser, a heated roller, a focused UV heating, a thermal radiation lamp, or a focused infrared heating, or any combination thereof.
54. Device according to any of the clauses 44 to 53, wherein the milling section is further configured for milling the at least one second side edge of the core layer such that at least one second coupling structure is formed, in particular a to the coupling structure complementary coupling structure, wherein the complementary coupling structure comprising at least one tongue and/or at least one groove.

It will be clear that the invention is not limited to the exemplary embodiments which are illustrated and described here, but that countless variants are possible within the framework of the attached claims, which will be obvious to the person skilled in the art. In this case, it is conceivable for different inventive concepts and/or technical measures of the above-described variant embodiments to be completely or partly combined without departing from the inventive idea described in the attached claims.

The verb ‘comprise’ and its conjugations as used in this patent document are understood to mean not only ‘comprise’, but to also include the expressions ‘contain’, ‘substantially contain’, ‘formed by’ and conjugations thereof.

1. A method for applying a pressed bevel to a decorative panel, comprising the steps of:
a) providing at least one decorative panel, said panel comprising at least one core layer and at least one decorative top layer, and an upper surface and at least one pair of opposing side edges;
wherein the at least one core layer comprises at least one thermoplastic composite material;
b) precutting at least part of at least one side edge of the panel;
c) locally heating a predetermined region of the upper surface of the panel along an outer edge with at least one laser;
d) deforming at least part of the heated predetermined region of the upper surface of the panel, such that at least one pressed bevel is formed at the at least one side edge of the panel;
e) subjecting the at least one side edge of the core layer to a milling process wherein at least one coupling structure is formed, said coupling structure comprising at least one tongue and/or at least one groove;
wherein steps c) and d) are performed substantially simultaneously such that it allows to perform the method at a production speed of at least 30 meters per minute.

2. The method according to claim 1, wherein step a), step b), the substantially simultaneous steps c) and d), and then step e) are performed subsequently.

3. The method according to claim 1, wherein step (a) is performed at room temperature and/or wherein step (d) is performed at room temperature, wherein the room temperature is within a range of 15 degrees Celsius to 25 degrees Celsius.

4. The method according to claim 1, wherein during step (d) at least part of the heated upper surface is deformed by pressing and/or rolling.

5. The method according to claim 1, wherein the at least one heating step is performed with at least one focused infrared laser.

6. The method according to claim 1, wherein the predetermined region heated by the at least one laser has a length and a width, wherein the length lies in a range of 150 mm to 450 mm and/or
wherein the width lies in a range of 0.5 mm to 4 mm.

7. The method according to claim 1, wherein locally heating of at least one predetermined region is performed such that at least a central region of the upper surface of the panel is substantially unaffected by the heating step, and/ow
wherein only an upper portion and/or edge portion of the panel is heated, up to a depth of 0.6 to 4 mm extending from the upper surface of the panel towards a bottom surface of the panel and/or a width of 0.5 mm to 6 mm measured from the outer edge of the panel.

8. The method according to claim 1, further comprising at least one cooling step after step d).

9. The method according to claim 1, the at least one thermoplastic composite material having a Vicat softening temperature of at least 60 degrees Celsius.

10. The method according to claim 1, wherein the at least one decorative top layer has a Vicat softening temperature of at most 70 degrees Celsius and/or wherein the Vicat softening temperature of the at least one decorative top layer is at least 10 degrees Celsius lower than the Vicat softening temperature of the at least one core layer.

11. The method according to claim 1, wherein the at least one decorative top layer is heated at a temperature of at least 5 °C to 20 °C above the glass transition temperature of the core layer.

12. The method according to claim 1, wherein the method is performed at a production speed of at least 60 meters per minute.

13. The method according to claim 1, comprising the step of aligning the at least one decorative panel prior to the at least one milling and/or heating step.

14. The method according to claim 1, comprising the step of subjecting the at least two opposing side edge of the core layer to a milling process wherein complementary coupling structures are formed, wherein each coupling structure comprises at least one tongue and/or at least one groove.

15. A decorative panel produced by the method according to claim 1.

16. A device for producing at least part of a decorative panel comprising a bevel, in particular a floor, wall, or ceiling panel, comprising:
at least one conveyor for transporting a panel along a transport path, wherein the panel comprises at least one core layer and at least one decorative top layer, and upper surface and at least one pair of opposing edges, wherein the at least one core layer comprises at least one thermoplastic composite material;
at least one primary processing section arranged along the transport path, wherein the primary processing section is configured to provide at least one precut to at least part of at least one side edge of the panel and in particular of the at least one core layer;
at least one heating section arranged along the transport path downstream with respect to the at least one primary processing section and comprising at least one laser, wherein the heating section is configured for locally heating, using the at least one laser, a predetermined region of the upper surface of the panel along an outer edge;
at least one bevelling section arranged along the transport path downstream with respect to the heating section, comprising at least one pressing element configured for deforming or impressing at least part of the heated upper surface of the panel such that at least one pressed bevel is formed at the at least one side edge of the panel,
at least one milling section arranged along the transport path downstream with respect to the at least one bevelling section, configured for milling the at least one side edge of the core layer such that at least one coupling structure is formed, said coupling structure comprising at least one tongue and/or at least one groove; wherein the at least one heating section and the at least one bevelling section are arranged such that the locally heating of the predetermined region and the deforming or impressing, of the at least part of the heated upper surface of the panel are performed substantially simultaneously such that it allows to perform the method at a production speed of at least 30 meters per minute.

17. The device according to claim 16, wherein the heating section is configured to heat an upper portion of the panel, having a thickness situated in range of 0.4 to 0.6 mm extending from the upper surface of the panel towards a bottom surface of the panel.

18. The device according to claim 16, wherein the at least one laser comprises a focussed infrared laser.

19. The device according to claim 16, wherein the bevelling section comprises at least one surface pressing structure and at least one back support structure, a roller, or any combination thereof.

20. The device according to claim 16, wherein the milling section is further configured for milling the at least one second side edge of the core layer such that at least one second coupling structure is formed, complementary to the at least one coupling structure, wherein the at least one second coupling structure comprising at least one tongue and/or at least one groove.
